(19) United States
(12) Patent Application Publication
(10) Pub. No.: US 2008/0133715 A1
(43) Pub. Date: Jun. 5, 2008

(54) Content playback system, playback device, playback switching method, and program

(75) Inventors: Michiaki Yoneda, Kanagawa (JP); Shigetaka Kudo, Kanagawa (JP); Takashi Koya, Kanagawa (JP); Taketeru Fujimoto, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/977,405

(22) Filed: Oct. 24, 2007

(30) Foreign Application Priority Data
Nov. 30, 2006 (JP) JP2006-323687

(51) Int. Cl. G06F 15/16

(52) U.S. Cl. 709/219

(57) ABSTRACT

There is provided a content playback system in which a first playback device and a second playback device that can receive and play back content from a server device are connected through a network. When the first playback device, while receiving and playing back the content from the server device, receives a switching command for causing the content that is currently being played back to be played back on the second playback device, the first playback device transmits through the network to the second playback device playback information that includes attribute information and an elapsed playback time for the content that is currently being played back. When the second playback device receives the playback information from the first playback device, the second playback device, based on the playback information, receives from the server device and plays back data that starts from the elapsed playback time for the content.

### CROSS REFERENCE TO RELATED APPLICATION

The present invention contains subject matter related to Japanese Patent Application JP 2006-323687 filed in the Japan Patent Office on Nov. 30, 2006, the entire contents of which being incorporated herein by reference.

### BACKGROUND OF THE INVENTION

1. Field of the Invention

The present invention relates to a content playback system, a playback device, a playback switching method, and a program.

2. Description of the Related Art

Known related art provides a content playback system which plays back content by transmitting audio and image content stored on a server to a client (playback device) through a network between the client and the server that are provided with communication functions, in accordance with the Transmission Control Protocol/Internet Protocol (TCP/IP).In the content playback system, the client generally issues a request to the server to search for the content that can be played back and to transmit a list of the content that can be played back. In response to the request, the client receives from the server the list of the content that can be played back. The client is also able to request that the server transmit the content that a user selects from the list, and can receive and play back the content that the server transmits in response.

As the content data is transmitted by streaming from the server, the client sequentially stores (buffers) the content data in a buffer temporarily. At a point when a specified amount of the data has been stored, the client reads the content data from the buffer and starts playing back the content. In a case where the client can handle only uncompressed digital data, the server decodes (expands) compressed digital data that has been compressed and encoded by an encoding system such as MPEG1 Audio Layer 3 (MP3) or the like, converts the data into uncompressed digital data, such as linear PCM data or the like, and transmits the data to the client.

Incidentally, it is conceivable that the content playback system could be configured such that a plurality of the clients are connected to the network and that each of the plurality of the clients receives the content from a server device and plays back the content. For example, in a home network where one client is installed in the living room and another client is installed in a bedroom, suppose that a user who was listening to music content on the client in the living room wants to move to the bedroom and continue listening to the music content in the bedroom. In that case, even though the user is playing back the same content that is on the same server, the user must perform a separate series of operations for each of the two clients, selecting the music content on the server, setting the playback mode, starting the playback, and the like. The user operations are thus cumbersome.

A technology that pertains to this problem is disclosed in Japanese Patent Application Publication No. JP-A-2005-242667. For each user, the technology registers setting information related to the music content playback operation in a setting information table on the server. In a case where the same playback operation is restarted on a different client, the technology makes it possible to call up the setting information that is registered on the server by pressing an operation key that corresponds to the desired playback operation, thus making it possible to restart the playback operation by a comparatively simple operation.

### SUMMARY OF THE INVENTION

However, the technology described in Japanese Patent Application Publication No. JP-A-2005-242667 registers on the server the playback operation setting information from each client. Therefore, the technology cannot be used unless a server is installed that has a registration function for the setting information. Moreover, in a case where the server that distributes the content and the server on which the setting information is registered are separate servers, the technology cannot be used unless the server on which the setting information is registered is in operation. For example, many manufacturers provide a wide variety of server models that conform to the DLNA standards, and it cannot be expected that all of these servers will be provided with the registration function for the setting information.

Furthermore, with the technology described in Japanese Patent Application Publication No. JP-A-2005-242667, even if the setting information is registered on the server, each client must operate separately to perform the playback operation, so there is room for improvement. The technology is also not capable of providing a continuous, seamless playback operation in real time between the clients.

Therefore, a method is desired that will make it possible for information to be shared among a plurality of playback devices (clients) that are connected by a wired connection or a wireless connection, without using a server for registering the setting information as described above, and that will make it possible for the playback operation that is currently in progress on one of the playback devices to be continued seamlessly on another playback device by performing a simple operation.

Accordingly, the present invention addresses the problems described above by providing a content playback system, a playback device, a playback switching method, and a program that are new and improved and that make it possible, by performing a simple operation, to switch the playback operation seamlessly among a plurality of playback devices that are connected by wire or wirelessly, without using a server for registering the setting information as described above.

According to an embodiment of the present invention, there is provided a content playback system in which a first playback device and a second playback device that can receive and play back content from a server device are connected by one of a wired connection and a wireless connection. When the first playback device, while receiving and playing back the content from the server device, receives a switching command for causing the content that is currently being played back to be played back on the second playback device, the first playback device transmits to the second playback device playback information that includes attribute information and an elapsed playback time for the content that is currently being played back. When the second playback device receives the playback information from the first playback device, the second playback device, based on the playback information, receives from the server device and plays back data that starts from the elapsed playback time for the content.

Furthermore, another embodiment of the present invention, there is provided a playback device that includes a communication portion, a playback portion, and a playback switching portion. The communication portion communicates data to and from at least one of a server device and an other playback device. The playback portion plays back content that is received from the server device by the communication portion. The playback switching portion, when it receives a switching command while the content is being played back by the playback portion, transmits to the other playback device through the communication portion playback information that includes attribute information and an elapsed playback time for the content that is currently being played back.

The playback information may further include playback mode information that indicates a playback mode that is currently set on the playback device.

Further, the playback mode may include at least one of a one track repeat playback mode, an album repeat playback mode, an all content continuous playback mode, a shuffle playback mode, and a random playback mode.

The playback mode information may also include playback range information that indicates a range of the content that is subject to playback.

The playback information may further include server information that pertains to the server device that is the transmission source for the content that is currently being played back.

The playback device may also be provided with a switching function setting portion that sets to ON and OFF a function by which the playback switching portion switches the playback of the content to the other playback device.

Additionally, the playback switching portion, when the switching command is received, may search for and find at least one other playback device that is capable of communicating data to and from the playback device, and then may determine which of the at least one other playback device that has been found is the playback device that is the destination of the playback switching of the content.

Furthermore, the playback switching portion, after the switching command is received, may stop the playback of the content by the playback portion and transmit to the other playback device the elapsed playback time at the time that the playback was stopped.

Moreover, the playback switching portion, after the playback information is transmitted to the other playback device, may transmit a playback start command to the other playback device.

The playback switching portion may also receive from the other playback device a playback start notification that the playback of the content has started on the other playback device.

Further, the playback switching portion, after it receives the playback start notification, may stop the playback of the content by the playback portion.

The playback device may also include an input portion and a display portion. The input portion may receive the switching command to cause the content that is currently being played back to be played back on the other playback device and may receive a content playback command. The display portion may display information that pertains to the content.

Moreover, the attribute information for the content that is currently being played back may include at least one of a title, an album name, an artist name, address information, a playback time, and an entire album playback time for the content that is currently being played back.

Furthermore, another embodiment of the present invention addresses the problems described above by providing a playback device that includes a communication portion, a playback portion, a playback switching portion, and a playback control portion. The communication portion communicates data to and from at least one of a server device and an other playback device. The playback portion plays back content that is received from the server device by the communication portion. The playback switching portion receives from the other playback device through the communication portion playback information that includes attribute information and an elapsed playback time for the content that is currently being played back on the other playback device. The playback control portion, based on the playback information, receives from the server device through the communication portion data that starts from the elapsed playback time for the content and performs control such that the content is played back by the playback portion.

The playback information may further include playback mode information that indicates a playback mode that is currently set on the other playback device. The playback control portion may perform control such that the content is played back based on the playback mode information.

Further, the playback mode may include at least one of a one track repeat playback mode, an album repeat playback mode, an all content continuous playback mode, a shuffle playback mode, and a random playback mode.

The playback mode information may also include playback range information that indicates a range of the content that is subject to playback. The playback control portion, based on the playback range information, may specify the playback range of the content that is played back by the playback portion.

The playback information may further include server information that pertains to the server device that is the transmission source for the content that is currently being played back. The playback control portion, based on the server information, may specify the server device that is the transmission source for the content that is currently being played back.

The playback device may also be provided with a switching function setting portion that sets to ON and OFF a function by which the playback switching portion switches the playback of the content from the other playback device.

Moreover, the playback control portion, after a playback start command is received from the other playback device, may perform control such that the playback of the content by the playback portion starts, based on the playback information.

Furthermore, the playback switching portion, after the playback of the content by the playback portion has started, may transmit a playback start notification to the other playback device.

The playback device may also include an input portion and a display portion. The input portion may receive the switching command to cause the content that is currently being played back to be played back on the other playback device and may receive a content playback command. The display portion may display information that pertains to the content.

Moreover, the attribute information for the content that is currently being played back may include at least one of a title, an album name, an artist name, address information, a playback time, and an entire album playback time for the content that is currently being played back.

Furthermore, another embodiment of the present invention, there is provided a playback switching method in a playback device that is connected by one of a wired connection and a wireless connection to at least one of a server device and an other playback device. The playback switching method includes a step of receiving content from the server device and playing back the content. The playback switching method also includes a step of receiving a switching command, while the content is being played back, to play back on the other playback device the content that is currently being played back. The playback switching method also includes a step of transmitting to the other playback device, in response to the receiving of the switching command, playback information that includes attribute information and an elapsed playback time for the content that is currently being played back.

Furthermore, another embodiment of the present invention, there is provided a playback switching method in a playback device that is connected by one of a wired connection and a wireless connection to at least one of a server device and an other playback device. The playback switching method includes a step of receiving from the other playback device playback information that includes attribute information and an elapsed playback time for the content that is currently being played back on the other playback device. The playback switching method also includes a step of performing control, based on the playback information, such that data that starts from the elapsed playback time for the content is received from the server device and played back.

Furthermore, another embodiment of the present invention, there is provided a program that causes a computer that makes up a playback device that is connected by one of a wired connection and a wireless connection to at least one of a server device and an other playback device to perform a series of steps. The first is a step of receiving content from the server device and- playing back the content. The second is a step of receiving a switching command, while the content is being played back, to play back on the other playback device the content that is currently being played back. The third is a step of transmitting to the other playback device, in response to the receiving of the switching command, playback information that includes attribute information and an elapsed playback time for the content that is currently being played back.

Furthermore, another embodiment of the present invention, there is provided a program that causes a computer that makes up a playback device that is connected by one of a wired connection and a wireless connection to at least one of a server device and an other playback device to perform a series of steps. The first is a step of receiving from the other playback device playback information that includes attribute information and an elapsed playback time for the content that is currently being played back on the other playback device. The second is a step of performing control, based on the playback information, such that data that starts from the elapsed playback time for the content is received from the server device and played back.

Furthermore, another embodiment of the present invention, there is provided a content playback system in which a first playback device and a second playback device that can receive and play back content from a server device are connected by one of a wired connection and a wireless connection. When the first playback device receives a switching command for causing the content that is currently being played back on the second playback device to be played back on the first playback device, the first playback device transmits to the second playback device a transmission request for playback information. When the second playback device, while receiving and playing back the content from the server device, receives from the first playback device the transmission request for the playback information, the second playback device transmits to the first playback device playback information that includes attribute information and an elapsed playback time for the content that is currently being played back. When the first playback device receives the playback information from the second playback device, the first playback device, based on the playback information, receives from the server device and plays back data that starts from the elapsed playback time for the content.

Furthermore, another embodiment of the present invention, there is provided a playback device that includes a communication portion, a playback portion, a playback switching portion, and a playback control portion. The communication portion communicates data to and from at least one of a server device and an other playback device. The playback portion plays back content that is received from the server device by the communication portion. The playback switching portion, when it receives a switching command, transmits to the other playback device through the communication portion a transmission request for playback information and, in response to the transmission of the transmission request for the playback information, receives from the other playback device through the communication portion the playback information that includes attribute information and an elapsed playback time for the content that is currently being played back on the other playback device. The playback control portion, based on the playback information, receives from the server device, through the communication portion, data that starts from the elapsed playback time for the content and performs control such that the content is played back by the playback portion.

The playback information may further include playback mode information that indicates a playback mode that is currently set on the other playback device. The playback control portion may perform control such that the content is played back based on the playback mode information.

Further, the playback mode may include at least one of a one track repeat playback mode, an album repeat playback mode, an all content continuous playback mode, a shuffle playback mode, and a random playback mode.

The playback mode information may also include playback range information that indicates a range of the content that is subject to playback. The playback control portion, based on the playback range information, may specify the playback range of the content that is played back by the playback portion.

The playback information may further include server information that pertains to the server device that is the transmission source for the content that is currently being played back. The playback control portion, based on the server information, may specify the server device that is the transmission source for the content that is currently being played back.

The playback device may also be provided with a switching function setting portion that sets to ON and OFF a function by which the playback switching portion switches the playback of the content from the other playback device.

Additionally, the playback switching portion, when the switching command is received, may search for and find at least one other playback device that is capable of communicating data to and from the playback device, and then may determine which of the at least one other playback device that has been found is the playback device that is the source of the playback switching of the content.

Moreover, the playback switching portion, after the playback information is transmitted to the other playback device, may transmit a playback stop command to the other playback device.

The playback switching portion may also receive from the other playback device a playback stop notification that playback of the content has stopped on the other playback device.

Further, the playback switching portion, after it receives the playback stop notification, may start the playback of the content by the playback portion.

Furthermore, another embodiment of the present invention, there is provided a playback device that includes a communication portion, a playback portion, and a playback switching portion. The communication portion communicates data to and from at least one of a server device and an other playback device. The playback portion plays back content that is received from the server device by the communication portion. The playback switching portion, when it receives from the other playback device through the communication portion a transmission request for playback information while the content is being played back by the playback portion, transmits to the other playback device playback information that includes attribute information and an elapsed playback time for the content that is currently being played back.

The playback information may further include playback mode information that indicates a playback mode that is currently set on the playback device.

Further, the playback mode may include at least one of a one track repeat playback mode, an album repeat playback mode, an all content continuous playback mode, a shuffle playback mode, and a random playback mode.

The playback mode information may also include playback range information that indicates a range of the content that is subject to playback.

The playback information may further include server information that pertains to the server device that is the transmission source for the content that is currently being played back.

The playback device may also be provided with a switching function setting portion that sets to ON and OFF a function by which the playback switching portion switches the playback of the content to the other playback device.

Moreover, the playback control portion, after a playback stop command is received from the other playback device, may stop the playback of the content by the playback portion.

Furthermore, the playback switching portion, after the playback of the content by the playback portion has stopped, may transmit a playback stop notification to the other playback device.

Furthermore, another embodiment of the present invention, there is provided a playback switching method in a playback device that is connected by one of a wired connection and a wireless connection to at least one of a server device and an other playback device. The playback switching method includes a step of receiving a switching command to play back on the playback device content that is currently being played back on the other playback device. The playback switching method also includes a step of transmitting to the other playback device, in response to the receiving of the switching command, a transmission request for playback information. The playback switching method also includes a step of receiving from the other playback device, in response to the transmission of the transmission request for the playback information, the playback information that includes attribute information and an elapsed playback time for the content that is currently being played back on the other playback device. The playback switching method also includes a step of performing control, based on the playback information, such that data that starts from the elapsed playback time for the content is received from the server device and played back.

Furthermore, another embodiment of the present invention, there is provided a playback switching method in a playback device that is connected by one of a wired connection and a wireless connection to at least one of a server device and an other playback device. The playback switching method includes a step of receiving content from the server device and playing back the content. The playback switching method also includes a step of receiving from the other playback device, while the content is being played back, a transmission request for playback information. The playback switching method also includes a step of transmitting to the other playback device, in response to the receiving of the transmission request, the playback information that includes attribute information and an elapsed playback time for the content that is currently being played back.

Furthermore, another embodiment of the present invention, there is provided a program that causes a computer that makes up a playback device that is connected by one of a wired connection and a wireless connection to at least one of a server device and an other playback device to perform a series of steps. The first is a step of receiving a switching command to play back on the playback device content that is currently being played back on the other playback device. The second is a step of transmitting to the other playback device, in response to the receiving of the switching command, a transmission request for playback information. The third is a step of receiving from the other playback device, in response to the transmission of the transmission request for the playback information, the playback information that includes attribute information and an elapsed playback time for the content that is currently being played back on the other playback device. The fourth is a step of performing control, based on the playback information, such that data that starts from the elapsed playback time for the content is received from the server device and played back.

Furthermore, another embodiment of the present invention, there is provided a program that causes a computer that makes up a playback device that is connected by one of a wired connection and a wireless connection to at least one of a server device and an other playback device to perform a series of steps. The first is a step of receiving content from the server device and playing back the content. The second is a step of receiving from the other playback device, while the content is being played back, a transmission request for playback information. The third is a step of transmitting to the other playback device, in response to the receiving of the transmission request, the playback information that includes attribute information and an elapsed playback time for the content that is currently being played back.

According to the embodiments of the present invention described above, it is possible, by performing a simple operation, to switch a playback operation seamlessly among a plurality of playback devices that are connected by one of a wired connection and a wireless connection, without using a server for registering setting information for the playback operation.

### BRIEF DESCRIPTION OF THE DRAWINGS

FIG. 1 is an explanatory figure that shows a configuration of a home network system according to a first embodiment of the present invention;

FIG. 2 is a block diagram that shows a configuration of a server device according to the embodiment;

FIG. 3 is a block diagram that shows a configuration of a playback device according to the embodiment;

FIG. 4 is an explanatory figure that shows specific examples of operation buttons for inputting playback operation switching commands to the playback device according to the embodiment;

FIG. 5 is an explanatory figure that shows specific examples of a remote controller for inputting the playback operation switching commands to the playback device according to the embodiment, and operation buttons thereof;

FIG. 6 is an explanatory figure that shows an overview of a streaming transmission process and a streaming playback process according to the embodiment;

FIG. 7 is an explanatory figure that shows an overview of a playback switching operation in a first case according to the embodiment;

FIG. 8 is a sequence chart that shows a playback switching method in the first case according to the embodiment;

FIG. 9 is an explanatory figure that shows an overview of a playback switching operation in a second case according to the embodiment;

FIG. 10 is a sequence chart that shows a playback switching operation in the second case according to the embodiment;

FIG. 11 is an explanatory figure that shows an overview of a playback switching operation in a third case according to the embodiment; and

FIG. 12 is an explanatory figure that shows an overview of a playback switching operation in a fourth case according to the embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

System Configuration

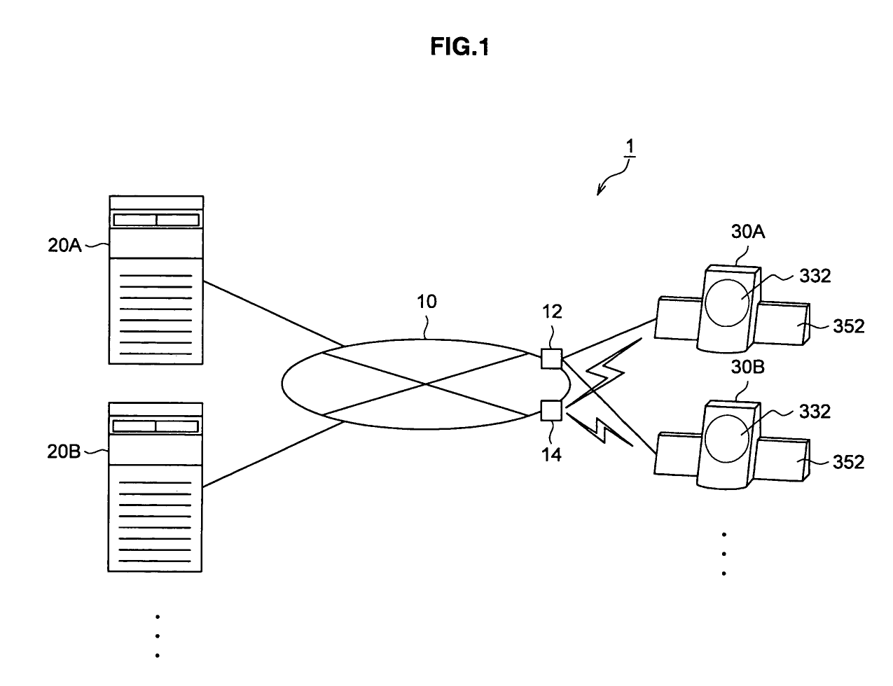

First, a home network system 1 according to a first embodiment of the present invention will be explained with reference to FIG. 1. FIG. 1 is an explanatory figure that shows a configuration of the home network system 1 according to the present embodiment. Note that the home network system 1 according to the present embodiment is an example of a content playback system.

As shown in FIG. 1, the home network system 1 is a network system that is provided inside a user's home or the like, for example, and that is configured by interconnecting a plurality of devices. In the home network system 1, a plurality of server devices 20A, 20B, and the like (hereinafter sometimes generically called “the server device(s) 20”) and a plurality of playback devices 30A, 30B, and the like (hereinafter sometimes generically called “the playback device(s) 30”), for example, are connected such that they are capable of mutual data communication through a switching hub, 12, an access point 14, and a household local area network (LAN) 10, which is an example of a network. The server devices 20 are configured as home servers in the home network system 1 and function as content provider servers that provide content to each of the playback devices 30. The playback devices 30 are equivalent to clients of the server devices 20 and have a function to play back the content that is transmitted from the server devices 20 while receiving the content.

In the present embodiment, the content may be any form of content, such as audio content like music, lectures, radio programs, and the like, video content like motion pictures, television programs, video programs, and the like that are made up of image data and/or audio data, game content, and the like. The present invention will be explained below using the audio content, particularly the music content, as an example of the content, but the content of the present invention is not limited by this example.

The LAN 10 is a communication network that connects, for example, a plurality of devices (the server devices 20, the playback devices 30) that are used within a household. The LAN 10, regardless of whether it is wired or wireless, may take the form of a wired Ethernet® such as 10base2, 1000baseT, or the like, for example. The LAN 10 may also take the form of a wireless LAN that is specified by the 802.11 Working Group of the Institute of Electrical and Electronics Engineers, Inc. (IEEE), for example.

When data is transmitted and received between the server devices 20 and the playback devices 30 through the LAN 10, the switching hub 12 serves as a relay device and is configured from an Internet switch or the like, for example. The switching hub 12 has a hub function that connects the devices on the LAN 10, analyzing the data that is sent from the transmission source device to detect the destination, then transmitting the data only to the destination device. The load on the entire home network system 1 can thus be lightened, and security can be improved. Note that a broadband router (not shown in the figures) that has a router function that relays data between the LAN 10 and an external public circuit network may also be provided on the LAN 10 instead of or in addition to the switching hub 12.

The access point 14 is a radio relay device for wireless communication that connects devices to achieve a wireless LAN function in the LAN 10. For example, the access point 14 (wireless parent unit) and the server devices 20 are connected by wire in an Ethernet®, and the playback devices 30 are connected wirelessly to the access point 14 by wireless child units. Using the access point 14 makes it possible for the server devices 20 and the playback devices 30 to perform wireless communications simultaneously with a plurality of other devices, for example.

Note that the form in which the various devices in the network are connected is not limited by the examples described above, and any form of connection may be used in which data communication among the devices is possible. For example, only one of the switching hub 12 and the access point 14 may be provided, and a separate relay device other than the switching hub 12 and the access point 14 may be added. The plurality of devices may also perform wireless communications directly in an ad hoc mode, without going through the access point 14.

The server device 20 (home server) is configured, for example, as a Digital Media Server (DMS) that can record, store, and distribute content. For the server device 20, it is possible, for example, to use DLNA-compatible devices that conform to the Digital Living Network Alliance (DLNA) guidelines and that transmit and receive data. The server devices 20 are configured from laptop and desktop personal computers, for example, but it is also possible to configure the server devices 20 from various types of information processing devices, such as network storage devices, home network server devices, data recording devices (DVD and HDD recorders and the like), game devices, intelligent electrical appliances, and the like.

The server device 20 acquires and stores a plurality of music content files. For example, through a public circuit network such as the Internet, a wide area network (WAN), or the like, the server device 20 receives the distribution of content from a content distribution server (not shown in the figures) that provides a content distribution service, then stores the distributed content in a storage device such as a hard disk drive (HDD) or the like. The server device 20 can also create new content by self-recording (of sounds, images, and the like), ripping, and the like and store the new content in the storage device, a removable storage medium, and the like. Note that self-recording means the recording as digital data of images and sounds that are photographed and collected by a photographic device and a sound collecting device that are ancillary to the server device 20. Ripping means extracting digital content that is recorded in a recording medium such as a music CD, a video DVD, or the like, converting the content into a file format that can be processed on a computer, and recording the content in the storage device or the removable storage medium.

Thus the content that is stored on the server device 20 may be uncompressed digital data (hereinafter called “uncompressed data”) such as linear pulse code modulation (PCM) data or the like, for example, and it may be compressed digital data (hereinafter called simply “compressed data”) that was compressed by any one of various types of compression encoding methods. In the case of music content, examples of compression encoding methods include Adaptive Transform Acoustic Coding (ATRAC), ATRAC3, MPEG1 Audio Layer 3 (MP3), Advanced Audio Coding (AAC), Windows Media Audio (WMA), and the like.

From among the plurality of the content files that the server device 20 stores, such as music content that is stored in the storage device, music content that is stored in a removable storage medium such as a CD, a DVD, and the like, Web radio music content that is received through the Internet, and the like, the server device 20 uses a streaming method (hereinafter called “streaming transmission”) to transmit to the playback device 30 through the LAN 10 the content for which a transmission request was received from the playback device 30. Here, the streaming method is a method for transmitting the data in synchronization with the content processing speed (for example, the playback speed) of the device that receives the data (the playback device 30). The playback device 30 can thus play back the content that is streamed from the server device 20 while receiving the content. In a case where the content is compressed data, the server device 20 first expands the compressed data and converts it into the uncompressed data (for example, the linear PCM data), then transmits it to the playback device 30.

The server device 20 can also transmit to the playback device 30 a content list that lists information that pertains to the plurality of the music content files (for example, a track title, an album title, an artist name, address information (Uniform Resource Locator (URL) or the like), a sampling frequency, a number of channels, a number of bits, codec information, and the like) using a determined unit (for example, album units, artist units).

The playback device 30 is a Digital Media Player (DMP) that is capable of playing back the content. The playback device 30 can, for example, be a DLNA-compatible device that conforms to the DLNA guidelines and transmits and receives data, in the same manner as the server device 20. In the present embodiment, the playback device 30 is configured as a network audio client device, for example. The playback device 30 that is configured as a network audio client device is provided with, for example, a display portion 332 (an LCD panel or the like) that is a user interface, and an audio output portion to output the sound of the music content that is played back. The audio output portion may be an externally mounted speaker 352, for example. However, the playback device according to the present invention is not limited by this example and may also be configured from a laptop personal computer, a mobile music player, an audio-visual component, a personal digital assistant (PDA), a home game device, a mobile game device, a mobile telephone, a PHS, a data playback device (a DVD/HDD player or the like), an intelligent electrical appliance such as a television receiver or the like, for example.

The playback device 30 has a function that selects the server device 20, a function that acquires the content list from the server device 20, a function that selects the content to be played back, a function that receives the content to be played back from the server device 20, and a function that plays back and outputs the content. Specifically, the playback device 30 searches for one, two, or more of the server devices 20 that are connected to the LAN 10 and are in operation, then selects from among the server devices 20 that it has found, automatically or based on a user operation or the like, the server device 20 from which it will receive the provision of the content. The playback device 30 also acquires from the selected server device 20 information (the content list) that pertains to the plurality of the content files that are stored on the server device 20, then displays the information on the display portion 332. The user can examine the content list, set the content desired for playback, and set the playback mode. In response to the content selection and the like, the playback device 30 issues a request to the server device 20 to transmit the selected content in accordance with the set playback mode. In response to the content transmission request, the server device 20 streams the content to the playback device, and the playback device 30, while receiving the content and storing it in a buffer, performs a digital-to-analog conversion of the content and outputs the converted content.

As described above, the server device 20 and the playback device 30 according to the present embodiment are both DLNA-compatible devices, for example, and mutually transmit and receive data according to a communications protocol, such as the Transmission Control Protocol/Internet Protocol (TCP/IP), for example, through a LAN 10 that consists of an Ethernet® and/or a wireless LAN. The server device 20 and the playback device 30 become usable simply by connecting them to the LAN 10. The playback device 30 (DMP) searches for the server devices 20 (DMS) that are present within the home network system 1 and automatically acquires from the server devices 20 the lists of the content that can be played back. If the user simply selects the content that he wants to see/hear from the lists acquired from the server devices 20, the content is automatically provided from the server device 20 to the playback device 30 and played back. Note that the server device 20 may also have a content playback function like that of the playback device 30.

Server Device 20 Configuration

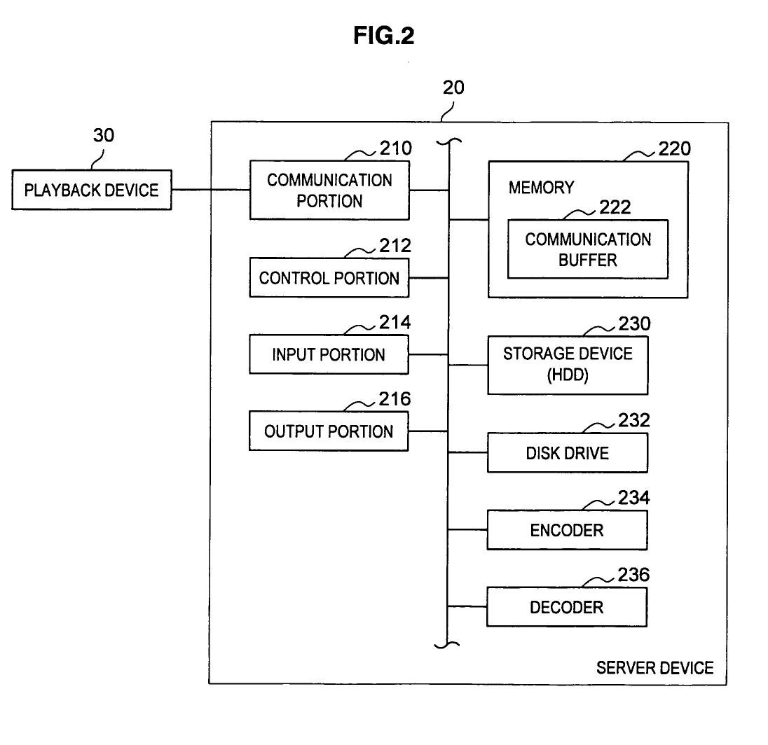

Next, the configuration of the server device 20 according to the present embodiment will be explained with reference to FIG. 2. FIG. 2 is a block diagram that shows the configuration of the server device 20 according to the present embodiment.

As shown in FIG. 2, the server device 20 is provided with a communication portion 210, a control portion 212, an input portion 214, an output portion 216, a memory 220 that has a communication buffer 222, a storage device 230, a disk drive 232, an encoder 234, and a decoder 236.

The communication portion 210 is a communications interface that is configured from a communications device or the like that performs data communications with an external device through the network. The communication portion 210 transmits and receives various types of data to and from the playback devices 30 and other external devices through the LAN 10, based on control by the control portion 212. The communication portion 210 can be compatible with Ethernet® and Giga Ethernet®, for example. In an environment where direct communication is possible with the access point 14 for wireless communications, the communication portion 210 can also be compatible with wireless communications such as Bluetooth, 802.11a/b/g, and the like. When transmitting and receiving various types of information, the communication portion 210 can control the volume of data communicated by storing the communicated data temporarily in the communication buffer 222.

The communication portion 210 transmits and receives various types of information, such as the content that the server device 20 stores, the content list, content attribute information, the content transmission request, a content list request, a control signal, and the like. The communication portion 210 can also transmit and receive various types of information, such as the content, a content distribution request, and the like, to and from the content distribution server (not shown in the figures) through a public circuit network (not shown in the figures).

The control portion 212 is configured from a central processing unit (CPU), a read-only memory (ROM), a random access memory (RAM), and the like, for example. The control portion 212 operates according to various types of programs that are stored in the ROM and the storage device 230 and controls the overall operation of the server device 20. For example, the control portion 212 controls the transmission and receiving of the various types of data to and from the playback devices 30 through the communication portion 210. Specifically, the control portion 212 controls the processing by which, in response to the content transmission request from the playback device 30, the compressed data for the content is read out from the storage device 230, the compressed data is converted to the uncompressed data by the decoder 236, and the uncompressed data is streamed to the playback device 30 by the communication portion 210. The streaming processing will be described in detail later. The control portion 212 also functions as a ripping portion that can use the disk drive 232 and the encoder 234 to rip music content (tracks) and video content from a removable storage medium such as a music CD, a video DVD, or the like that is loaded into the disk drive 232, and store the content in the storage device 230.

The input portion 214 is configured from an operation portion, an input control circuit, and the like. The operation portion is, for example, a mouse, a keyboard, a touch panel, a button, a switch, a lever, or the like. The input control circuit generates an input signal and outputs it to the control portion 212. By operating the input portion 214, the user of the server device 20 can input various types of data into the server device 20 and command the processing operations of the server device 20.

The output portion 216 is configured from a cathode ray tube (CRT) display device, a liquid crystal display (LCD) device, an audio output device, and the like. The audio output device is a speaker or the like. The content that is played back on the server device 20 is displayed/output as audio through the output portion 216.

The memory 220 is configured from a static random access memory (SRAM), a dynamic random access memory (DRAM), a synchronous DRAM (SDRAM), a Rambus DRAM (RDRAM), or the like, for example. The memory 220 temporarily stores (buffers) various types of data. During communications between the server device 20 and the playback device 30, for example, the memory 220 functions as the communication buffer 222 to transmit and receive the data smoothly. Note that the memory portion 220 can also function as a receiving buffer (not shown in the figures) that temporarily stores the compressed content data that is distributed from the content distribution server and transfers the compressed data to the decoder 236 in a stable manner.

The storage device 230 is a device for storing data and is configured from an HDD, for example. The storage device 230 drives a hard disk and stores various types of data, such as the programs that operate the control portion 212, and the compressed data for the ripped content, the distributed content, and the like. The storage device 230 functions as a content storage portion that stores a plurality of the content files and as a content information storage portion that stores attribute information for the content.

Note that in the storage device 230 according to the present embodiment, the hard disk serves as a storage medium, but the storage device 230 according to the present embodiment is not limited to this example. The storage medium may also be, for example, a non-volatile memory such as an electrically erasable programmable read-only memory (EEPROM), an erasable programmable read-only memory (EPROM), or the like, a magnetic disk such as a flexible disk or the like, an optical disk such as a compact disc recordable (CD-R), a compact disc rewritable (CD-RW), a digital versatile disc recordable (DVD-R), a digital versatile disc rewritable (DVD-RW), a dual-layer digital versatile disc recordable (DVD+R), a dual-layer digital versatile disc rewritable (DVD+RW), a digital versatile disc random access memory (DVD-RAM), a Blu-ray® disc recordable (BD-R), a dual-layer Blu-ray® disc recordable (BD-RE), or the like, or a magneto-optical (MO) disk or the like. The storage medium can also be a removable storage medium that can be loaded into and removed from the server device 20.

The disk drive 232 is an example of a recording and playback device for the removable storage medium. The disk drive 232 is built into or mounted externally on the server device 20. The disk drive 232 reads and writes various types of data, such as the content and the like, to and from the removable storage medium that is loaded into the disk drive 232. The removable storage medium is a magnetic disk, an optical disk, a magneto-optical disk, a semiconductor memory, or the like. Providing the disk drive 232 makes it possible, when a music CD, a video DVD, or the like is loaded into the server device 20, to rip the music content that is recorded on the music CD and the video content that is recorded on the video DVD.

The encoder 234, during the ripping and the self-recording, uses a specified compression encoding method (for example, MP3, ACC, ATRAC, ATRAC3, or the like) to compression encode the video/audio digital data to generate the compressed data for the music content, the video content, and the like. At this time, the encoder 234 compression encodes the content in specified encoding units, such as frame units, for example. Specifically, during the compression encoding, the control portion 212, based on a sample data string from the music content (track) that is to be compression encoded, sets the value of one frame to a specified number of samples n (for example, 1152 samples), then outputs each frame to the encoder 234. The compressed frames (for example, MP3 frames) that are produced by the encoder 234 are then recorded in the storage device 230 as the compressed data for the music content.

The decoder 236 decodes (expands) the compressed data for the music content or the like that is read out from the storage device 230 and converts it to the uncompressed data (for example, the linear PCM data). Under the control of the control portion 212, the uncompressed content data that is thus generated is then temporarily stored in the communication buffer 222 and transmitted to the playback device 30 through the LAN 10.

Playback Device 30 Configuration

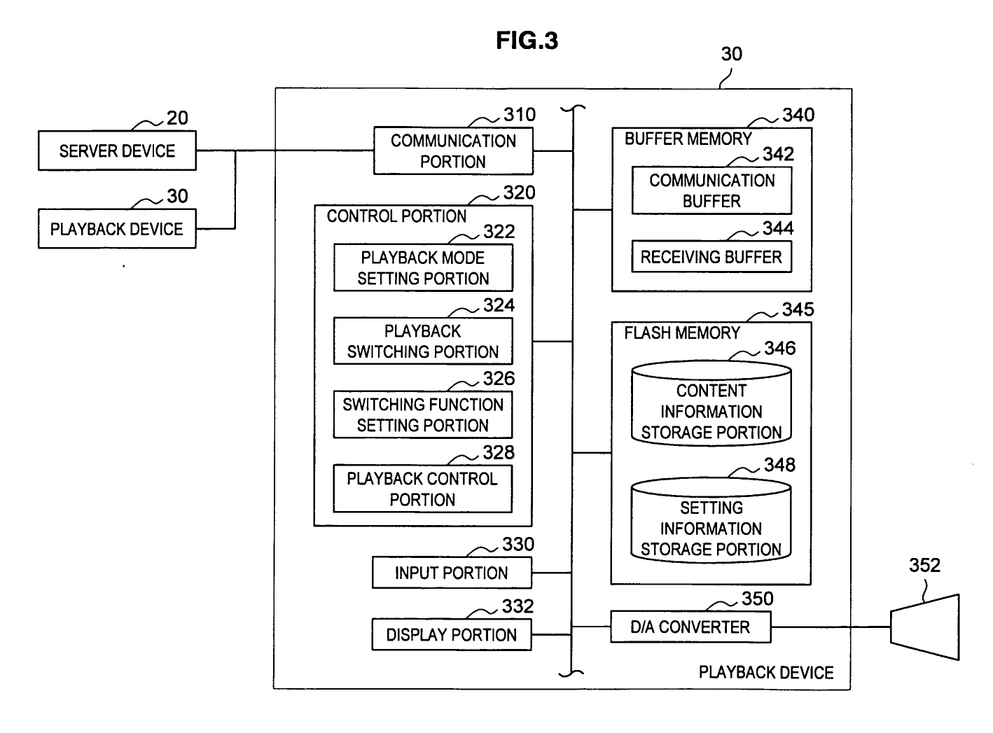

Next, the configuration of the playback device 30 according to the present embodiment will be explained with reference to FIG. 3. FIG. 3 is a block diagram that shows the configuration of the playback device 30 according to the present embodiment.

As shown in FIG. 3, the playback device 30 is provided with a communication portion 310, a control portion 320, an input portion 330, the display portion 332, a buffer memory 340 that has a communication buffer 342 and a receiving buffer 344, a flash memory 345, and a D/A converter 350. Note that, in this embodiment, a speaker 352 that is an audio output device is mounted externally on the playback device 30, but the playback device 30 is not limited by this example, and the audio output device, such as the speaker or the like, may also be built into the playback device 30.

The communication portion 310 is a communications interface that is configured from a communications device or the like that performs data communications with an external device through the network. The communication portion 310 transmits and receives various types of data to and from the server devices 20 and the other playback devices 30 through the LAN 10, based on control by the control portion 320. The communication portion 310 can be compatible with Ethernet® and Giga Ethernet®, for example. In an environment where direct communication is possible with the access point 14 for wireless communications, the communication portion 310 can also be compatible with wireless communications such as Bluetooth, 802.11a/b/g, and the like. When transmitting and receiving various types of information, the communication portion 310 can control the volume of data communicated by storing the communicated data temporarily in the communication buffer 342.

The communication portion 310 receives from the server device 20 the content list that lists the content that the server device 20 can provide, as well as the content attribute information. The communication portion 310 transmits to the server device 20 a request to transmit the content that the user selects from the content in the content list, then receives the uncompressed content data that is streamed from the server device 20. The communication portion 310 can also transmit to and receive from the other playback devices 30 various types of information that pertain to the switching of the content playback operation among the plurality of the playback devices 30. This will be described in detail later.

The control portion 320 is configured from a central processing unit (CPU), a ROM, a RAM, and the like, for example. The control portion 320 operates according to various types of programs that are stored in the ROM and controls the overall operation of the playback device 30. For example, the control portion 320 controls the communication portion 310 transmit and receive various types of data to and from an external device through the LAN 10. The control portion 320 also controls the communication portion 310, the D/A converter 350, and the speaker 352 to receive the content that is transmitted from the server device 20, store the content temporarily in the receiving buffer 344, read the content out of the receiving buffer 344, play back the content, output the audio, and the like.

The control portion 320 operates according to a program that is installed in the playback device 30. As shown in FIG. 3, the control portion 320 functions, for example, as a playback mode setting portion 322, a playback switching portion 324, a switching function setting portion 326, and a playback control portion 328.

The playback mode setting portion 322 sets the mode in which a playback portion (for example, the D/A converter 350) of the playback device 30 plays back the content. At this time, the playback mode setting portion 322 may set the playback mode based on a user input and may set the playback mode automatically based on mode setting information that is set in advance. The playback mode setting portion 322 writes playback mode setting information that indicates the set playback mode to a storage medium within the playback device 30, for example, to a setting information storage portion 348 that is configured from a non-volatile memory such as a flash memory or the like. Based on the playback mode setting information that is stored in the setting information storage portion 348, the playback control portion 328, which is described later, recognizes the order in which the music content within a specific playback range, such as an album, a playlist, or the like, is to be played back, then requests that the server device 20 transmit the music content in the order in which the music content will be played back.

Many different types of the playback mode can be set, according to whether or not repeat playback is used, whether or not shuffle or random playback is used, the range of the content to be played back (for example, a content group in which a plurality of related content files are grouped by the album, the artist, the genre, or the like), and the like. Examples of the playback mode include a one-track repeat playback mode, an album repeat playback mode, an all-content continuous playback mode, a shuffle playback mode, a random playback mode, and the like.

The one-track repeat playback mode is a playback mode in which one music content file (track) is played back repeatedly.

The album repeat playback mode is a playback mode in which a plurality of the music content files that belong to the same album are played back repeatedly in a specified order (for example, in track number order).

The all-content continuous playback mode (continue mode) is a playback mode in which all of the content in all of the albums is played back continuously.

The shuffle playback mode is a playback mode in which a plurality of the content files within a specified range (for example, the same album, the same artist, the same genre, the same playlist, or the like) are played back in an arbitrary order without duplication.

The random playback mode is a playback mode in which a plurality of the content files within a specified range are selected randomly and played back in an arbitrary order.

The playback switching portion 324 performs processing for the switching of the content playback among a plurality of the playback devices 30. The content playback switching processing will be explained. The content playback switching processing is processing that exchanges, among the playback devices 30 that are connected to a network such as the LAN 10 or the like, information related to the playback operation for the content that is currently being played back (that is, playback information), then switches the playback device 30 that performs the content playback operation among the playback devices 30. In the content playback switching processing, when a switching command is received while a certain playback device 30 (the playback switching source playback device 30) is playing back the content, the playback operation for the content that is currently being played back can be seamlessly switched to another of the playback devices 30 (the playback switching destination playback device 30), carrying over the playback mode, elapsed playback time, and the like of the playback operation on the playback switching source.

The playback switching processing is performed when the user performs a switching command operation on the input portion 330 of the playback device 30 and the playback device 30 receives the switching command. The user input operation for the switching command may be performed on the playback switching source playback device 30 (that is, the playback device 30 that is currently playing back the content) and may also be performed on the playback switching destination playback device 30 (that is, the playback device 30 that will continue the playback processing of the content that is currently being played back on another of the playback devices 30). In the former case, the content playback processing is switched to the playback switching destination playback device 30 from the playback switching source playback device 30 on which the switching command was input. (This is called a PUT of the content.) On the other hand, in the latter case, the content playback processing is switched from the playback switching source playback device 30 to the playback switching destination playback device 30 on which the switching command was input. (This is called a GET of the content.)

When the playback switching portion 324, which performs the playback switching operation, receives the switching command, the playback switching portion 324 reads from the setting information storage portion 348 information (a playback switching function ON/OFF setting) that was set by the switching function setting portion 326, which is described later. Based on the setting information, the playback switching portion 324 performs processing to determine whether or not the playback switching processing will be performed. If the processing result is that the playback switching processing will be performed, the playback switching portion 324 performs processing to identify the playback switching source and playback switching destination playback devices 30, based on information that indicates the playback switching source and playback switching destination playback devices 30 and that is included in switching setting information that is set by a user selection input or is set in advance. For example, when the playback switching portion 324 receives the switching command, it can search for and find the other playback devices 30 that are connected to the LAN 10 and are in operation, then identify the playback switching source or playback switching destination playback device 30 among the playback devices 30 it has found, based on the user selection input or the like.

There are two types of the switching command, a MOVE switching command (MOVE command) and a COPY switching command (COPY command). The MOVE switching command is a command that switches the content playback from the playback switching source playback device 30 to the playback switching destination playback device 30 and stops the content playback on the playback switching source playback device 30. The COPY switching command is a command that both plays back the content on the playback switching destination playback device 30 and continues the content playback on the playback switching source playback device 30.

The playback switching portion 324 also transmits and receives various types of data, such as the playback information that pertains to the playback operation of the content that is currently being played back, a request to transmit the playback information, a playback start command, a playback stop command, a playback start notification, a playback stop notification, and the like, to and from the playback devices 30 that the playback switching portion 324 has identified as the playback switching source and the playback switching destination. For example, in a case where the playback switching source playback device 30 receives the switching command, the playback switching portion 324 creates the playback information that pertains to the content that is currently being played back on the playback device 30, then transmits the playback information to the playback switching destination playback device 30. In a case where the playback switching destination playback device 30 receives the switching command, the playback switching portion 324 generates a request to transmit the playback information that pertains to the content that is currently being played back on the playback switching source playback device 30, then transmits the request to the playback switching source playback device 30.

Next, the playback information will be explained. The playback information according to the present embodiment includes (1) the content attribute information, (2) playback mode information, (3) the elapsed playback time, and (4) server information.

(1) Content Attribute Information

The content attribute information is, for example, address information that indicates the location of the content (for example, the content URL in the home network), a content title, a content ID, and the like. Each of the playback devices 30 can identify the content by the content attribute information. The content attribute information is acquired when the content is received from the server device 20 and is stored in a content information storage portion 346. When the switching command is received, or when a playback information transmission request is received, the playback switching portion 324 reads out from the content information storage portion 346 the attribute information for the content that is currently being played back on the playback switching source playback device 30 and appends it to the playback information.

(2) Playback Mode Information

The playback mode information is information that indicates the content playback mode on the playback switching source playback device 30. Each of the various types of playback modes described above can be set on the playback device 30. The playback mode includes the form of the playback for the content, such as whether or not it is repeated and the like. When the switching command is received, or when a playback information transmission request is received, the playback switching portion 324 appends to the playback information, as the playback mode information, information (for example, an identification code that corresponds to the playback mode) that can specify the playback mode that is set on the playback switching source playback device 30.

The playback mode information includes, in addition to the information that indicates the form of the playback for the content, playback range information that indicates a range of the content that is the object of the playback. The playback range information is a range that indicates the content group that is the object of the playback. The group includes the content that is currently being played back on the playback device 30. For example, the playback range is set by the album, by the artist, by the genre, by the playlist, or the like. For example, in a case where the playback device 30 is playing back continuously a plurality of the content files within a certain album, the playback range information is information that indicates the album. In a case where the playback device 30 is playing back continuously all of the content that belongs to a certain genre (for example, rock, pop, reggae, or the like), the playback range information is information that indicates the genre. In a case where the playback device 30 is playing back continuously the content that belongs to a certain artist, the playback range information is information that indicates the artist. When the switching command is received, or when a playback information transmission request is received, the playback switching portion 324 appends to the playback information, as the playback mode information, information that indicates the playback range that is set on the playback switching source playback device 30.

(3) Elapsed Playback Time

The elapsed playback time is the amount of time that has elapsed since the start of the playback of the content that is currently being played back. When the switching command is received, or when a playback information transmission request is received, the playback switching portion 324 appends to the playback information, as the playback mode information, elapsed playback time information for the content that is currently being played back.

(4) Server Information

The server information is information that pertains to the server device 20 that is the transmission source for the content that is currently being played back, such as identification information for the server device 20, for example. The identification information for the server device 20 may be, for example, a Universally Unique Identifier (UUID), a Media Access Control (MAC) address, or the like that is uniquely assigned to each device. When the switching command is received, or when a playback information transmission request is received, the playback switching portion 324 appends to the playback information the server information for the server device 20 that is the transmission source for the content that is currently being played back.

The playback switching portion 324 also issues to the playback control portion 328 commands that pertain to the content playback, based on the various types of information that are transmitted and received to and from the other playback devices 30. For example, in a case where the playback information is received from another of the playback devices 30, the playback switching portion 324, based on the playback information, issues a command to the playback control portion 328 to play back the content that is being switched. In response to the playback start commands, the playback stop commands, the playback start notifications, the playback stop notifications, and the like that are transmitted and received to and from the playback devices 30, the playback switching portion 324 also issues commands to the playback control portion 328 to perform the playback start processing and the playback stop processing.

The playback switching portion 324, in a case where the MOVE switching command is received, issues a command to the playback switching source playback device 30 to stop the content playback. On the other hand, in a case where the COPY switching command is received, the playback switching portion 324 issues a command to the playback switching source playback device 30 to continue (that is, not to stop) the content playback.

The switching function setting portion 326 sets to ON and OFF the function of the playback switching among the playback devices 30 that is performed by the playback switching portion 324. The switching function setting portion 326 stores the playback switching function ON/OFF setting information in the setting information storage portion 348. In a case where the playback switching function is set to OFF by the switching function setting portion 326, neither the processing that switches the playback from one's own playback device 30 to one of the other playback devices 30 nor the processing that switches the playback from one of the other playback devices 30 to one's own playback device 30 is performed, even if the switching command is input to the playback device 30 by the user, for example. It is thus possible to prevent the user from unintentionally switching the content playback among the playback devices 30.

The playback control portion 328 controls the processing by which the communication portion 310 is used to receive the content from the server device 20 through the LAN 10 and also controls the processing by which the playback portion (for example, the D/A converter 350) is used to play back the content that is received from the server device 20. More particularly, the playback control portion 328, in accordance with the setting information that the user specifies or that is set in advance, specifies to the server device 20 the content to be transmitted and requests the starting and ending of the content transmission. The playback control portion 328 also controls the content that is transmitted from the server device 20 such that the content is received through the communication portion 310. The playback control portion 328 also stores temporarily in the receiving buffer 344 the content that is received from the server device 20. The playback control portion 328 then reads out the content that is stored in the receiving buffer 344 and transfers it to the D/A converter 350, controlling the D/A converter 350 to convert the digital data to analog data and output the analog data to the speaker 352.

The playback control portion 328 not only performs the ordinary receiving and playback control processing described above, but also performs the receiving and playback control processing during the switching of the content playback among the playback devices 30. During the switching of the content playback, the playback control portion 328 makes it possible to seamlessly continue the playback operation of the content that is currently being played back on the playback switching source playback device 30, based on the playback information that the playback switching portion 324 acquired from the playback switching source playback device 30.

That is, in addition to specifying the server device 20 that is the transmission source of the content that is currently being played back on the playback switching source playback device 30, the playback control portion 328 specifies the playback start position for the content that is to be played back, based on the content attribute information and the elapsed playback time that are included in the playback information. The playback control portion 328 also transmits to the server device 20 that is the specified transmission source a request to transmit the specified content, starting at the playback start position for the content. Next, the playback control portion 328 performs control such that the data that starts at the point that corresponds to the elapsed content playback time is received from the server device 20 through the communication portion 310 and is stored temporarily in the receiving buffer 344. The playback control portion 328 then performs control such that the content data that is read out from the receiving buffer 344 is played back in order by the D/A converter 350. For example, in a case where the playback time of the content that is currently being played back is 5 minutes, 30 seconds, if the switching of the playback operation between the playback devices 30 occurs at a point when the elapsed playback time is 3 minutes, the contain data is played back on the playback switching destination playback device 30 starting at the 3-minute point.

At this time, based on the playback mode information that is included in the playback information, the playback control portion 328 sets the playback mode to the same playback mode that was used prior to the playback switching (for example, repeat or no repeat, the unit of repetition, shuffle or no shuffle, the playback range for continuous playback, and the like). The playback control portion 328 then performs control such that that content is played back according to the set playback mode. In other words, the playback control portion 328 not only controls the content for which the playback is switched while in progress, but also performs control such that a plurality of the other content files that follow the current content in the playback range will be received and played back in order according to the set playback mode.

The input portion 330 is configured from an operation portion, an input control circuit, and the like. The operation portion is made up of an operation key, such as a touch panel, a button, a switch, a lever, a dial, or the like, or of a remote controller and an optical receiver portion for the remote controller, for example. In response to a user input operation on the operation portion, the input control circuit generates an input signal and outputs it to the control portion 320. By operating the input portion 330, the user of the playback device 30 can input various types of data into the playback device 30 and command the processing operations of the playback device 30. Examples of the user input operations include selecting the server device 20, selecting from the content list the content to be played back, commanding the content playback operations, such as play, pause, fast forward, rewind, volume adjustment, and the like, selecting the playback mode, commanding the switching that switches the playback among the playback devices 30, selecting ON and OFF for the playback switching function, and the like.

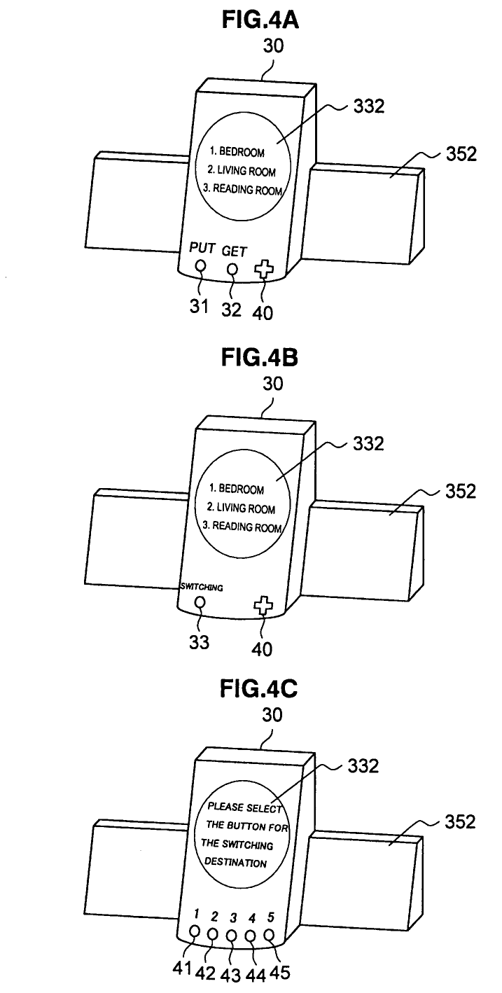

Next, specific examples of operations that use the input portion 330 to input the playback operation switching commands will be explained with reference to FIG. 4. FIG. 4 is an explanatory figure that shows specific examples of operation buttons that are provided on the main body of the playback device 30 for inputting switching commands to the playback device 30 according to the present embodiment.

In the example in FIG. 4A, the playback device 30 is provided with a PUT switching button 31 and a GET switching button 32. The PUT switching button 31 switches the playback operation of the content that is currently being played back on the playback device 30 on which the user is operating to another of the playback devices 30. The GET switching button 32 switches the playback operation of the content that is currently being played back on another of the playback devices 30 to the playback device 30 on which the user is operating. The user first operates a selector button 40 to select the playback device 30 to be the playback switching source or the playback switching destination. By pressing the PUT switching button 31, the user can then switch the playback operation of the content that is currently being played back on the playback device 30 on which the user is operating to the playback switching destination playback device 30. On the other hand, by pressing the GET switching button 31, the user can switch the playback operation of the content that is currently being played back on the playback switching source playback device 30 to the playback device 30 on which the user is operating.

In the example in FIG. 4B, the playback device 30 is provided with one switching button 33 to switch the playback operation among the playback devices 30. In this case, the user first operates the selector button 40 to select the playback device 30 to be the playback switching source or the playback switching destination. By pressing the switching button 33, the user can then switch the playback operation between the selected playback device 30 and the playback device 30 on which the user is operating. When the switching button 33 is pressed, the playback switching portion 324 determines whether or not the content is currently being played back on the playback device 30 on which the user is operating. In a case where the content is currently being played back on the playback device 30 on which the user is operating, the playback switching portion 324 switches (PUTs) the playback operation from the playback device 30 on which the user is operating to selected playback device 30. On the other hand, in a case where the playback is stopped on the playback device 30 on which the user is operating, the playback switching portion 324 switches (GETs) the playback operation from the selected playback device 30 to the playback device 30 on which the user is operating. Thus, in the example in FIG. 4B, the playback switching portion 324 can select the PUT and GET switching operations according to the playback circumstances on the playback device 30 on which the user is operating, so the user can perform the switching operation input using the one switching button 33.

In the example in FIG. 4C, the playback device 30 is provided with five switching buttons 41 to 45, for example, that respectively correspond to each of the plurality of the playback devices 30 that belong to the home network system 1. Thus, even if the user does not use the selector button 40 to perform an operation input that selects one of the playback devices 30, the user can switch the playback operation between the playback device 30 on which the user is operating and the desired playback device 30 by operating only one button, that is, pressing the one of the switching buttons 41 to 45 that corresponds to the desired playback device 30. At this time, the selection of the PUT or the GET switching operation may be determined automatically based on the playback circumstances, in the same manner as in the case shown in FIG. 4B.

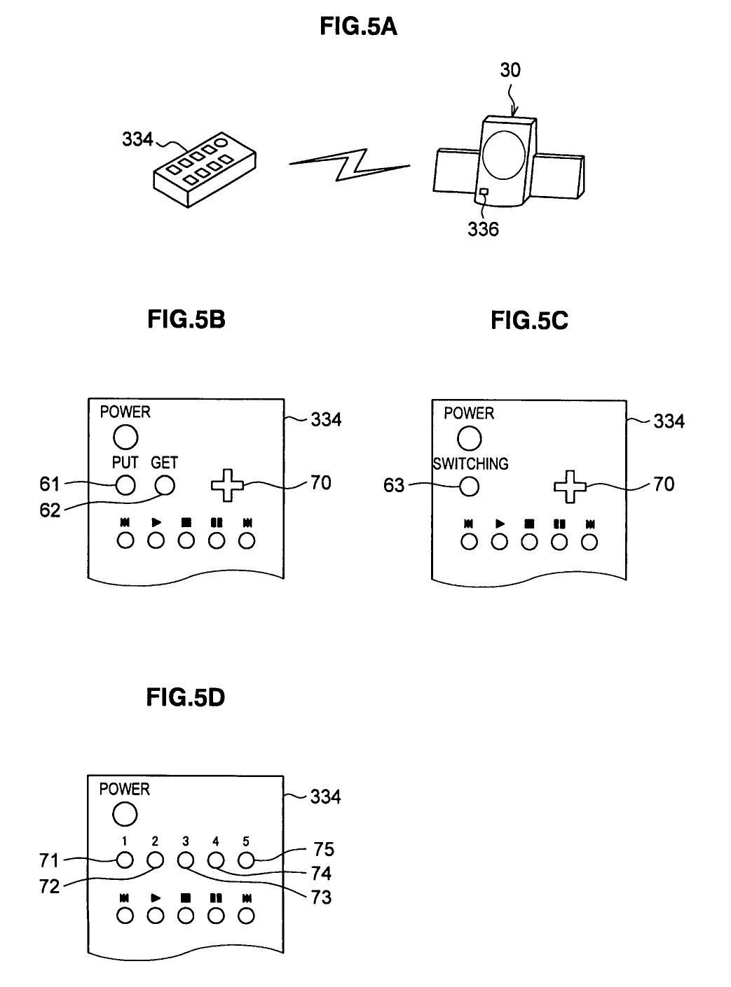

Next, specific examples of operations that use a remote controller 334 to input the playback operation switching commands will be explained with reference to FIG. 5. FIG. 5 is an explanatory figure that shows the remote controller 334 for inputting the playback operation switching commands to the playback device 30 according to the embodiment and specific examples of operation buttons that are provided on the remote controller 334.

As shown in FIG. 5A, the user may use the remote controller 334, which is configured as a separate unit from the playback device 30, to input the switching commands to the playback device 30. At this time, the remote controller 334 transmits to the playback device 30 main unit an infrared signal, for example, that indicates the switching command. The switching command is input to the playback device 30 when the infrared signal is received by the optical receiver portion 336 for the remote controller 334. The optical receiver portion 336 is an example of the input portion 330 of the playback device 30.

In this case, as shown in FIG. 5B, the remote controller 334 may also be provided with a PUT switching button 61 and a GET switching button 62, in the same manner as the example in FIG. 4A. The PUT switching button 61 switches the playback operation of the content that is currently being played back on the playback device 30 on which the user is operating to another of the playback devices 30. The GET switching button 62 switches the playback operation of the content that is currently being played back on another of the playback devices 30 to the playback device 30 on which the user is operating. The user first operates a selector button 70 to select the playback device 30 to be the playback switching source or the playback switching destination. By pressing the switching buttons 61 and 62, the user can then switch (PUT and GET) the playback operation between the playback devices 30.

As shown in FIG. 5C, remote controller 334 may also be provided with one switching button 63 to switch the playback operation among the playback devices 30, in the same manner as the example in FIG. 4B. The one switching button 63 can thus be used to perform both the PUT and GET switching functions between the playback devices 30.

As shown in FIG. 5D, remote controller 334 may also be provided with five switching buttons 71 to 75, for example, that respectively correspond to each of the plurality of the playback devices 30 that belong to the home network system 1, in the same manner as the example in FIG. 4C. Thus, the user can switch the playback operation between the playback device 30 on which the user is operating and the desired playback device 30 by operating only one button, that is, pressing the one of the switching buttons 71 to 75 that corresponds to the desired playback device 30.

Next, the configuration of the playback device 30 will be explained, again with reference to FIG. 3. The display portion 332 is configured from a display device such as a liquid crystal display (LCD) device, for example. The display portion 332 displays the playback circumstances and the like, such as the content list and the content attribute information that were received from the server device 20, the elapsed playback time, and the like. The user can select the desired content data based on the content list display. In relation to the playback switching function among the playback devices 30, the display portion 332 can also display identification information for the playback devices 30 that can become the playback switching source and the playback switching destination (the playback devices 30 that are connected to the LAN 10 and are in operation). A friendly name or the like that is a device name that is assigned to each of the playback devices 30, based on the UUID, the MAC address, a user input, or the like, can be used as an example of the identification information.

The buffer memory 340 is a storage portion that is configured, for example, from an SDRAM, an SRAM, a DRAM, an RDRAM, or the like. The buffer memory 340 temporarily stores various types of data. The buffer memory 340 functions as the communication buffer 342 and the receiving buffer 344.

The communication buffer 342 is a buffer that temporarily stores the communication data so that the data will be transmitted and received smoothly during communications between the playback device 30 and the server device 20, for example.

The receiving buffer 344 is configured as a ring buffer, for example, and is an example of a buffer that temporarily stores the uncompressed data that is received from the server device 20 through the communication portion 310. The uncompressed data that is temporarily stored in the receiving buffer 344 is read out and forwarded to the D/A converter 350 by the playback control portion 328 of the control portion 320.

Note that in the present embodiment, the communication portion that performs D/A conversion of the uncompressed data that is read out from the receiving buffer 344. The D/A converter 350 converts the uncompressed data that is read out from the receiving buffer 344 from a digital format to an analog format, then outputs an analog format playback signal to the speaker 352. For example, the D/A converter 350 can use a current summing method to convert the uncompressed linear PCM data into the analog format playback signal. The playback signal that is generated by the conversion to the analog format is output to the speaker 352, which is an example of an audio output portion and which outputs the signal as sound. Note that the D/A converter portion may be configured from hardware like the D/A converter 350, but it may also be configured from software. The audio output portion is not limited to the example of the speaker 352. Anything, such as a headset, earphones, and the like, that is compatible with the type of the playback device 30 can be used as the audio output portion.

The home network system 1 according to the present embodiment, as well as the server device 20 and the playback device 30 that are component elements of the home network system 1, have been explained with reference to FIGS. 1 to 5. The operation of the home network system 1 that is configured as described above will be explained below.

Overall System Operation

First, an overview of the content playback operation in the home network system 1 will be explained.

In a case where the content that is stored on the server device 20 is played back on the playback device 30, the playback device 30 first requests that the server device 20 transmit the content list. When the server device 20 transmits the content list, which is a list of the content that can be transmitted, to the playback device 30 in response to the transmission request, the playback device 30 displays the content list that was received from the server device 20 on the display portion 332. Next, when the user selects the desired content for playback from the content list, the playback device 30 issues a transmission request for the selected content to the server device 20. In response to the transmission request, the server device 20 expands (decodes) the compressed data for the content, converts it to the uncompressed data (for example, the linear PCM data) that is compatible with the playback device 30, then streams the uncompressed data to the playback device 30. The playback device 30 then plays back the streamed uncompressed data while receiving the uncompressed data. In the playback processing, the playback device 30, while storing the received uncompressed data temporarily in the receiving buffer 344, reads the uncompressed data out of the receiving buffer 344, performs the D/A conversion of the uncompressed data, generates the analog format playback signal, and outputs sound from the speaker 352.

Thus, in the present embodiment, the compressed content data that is stored on the server device 20 can be expanded with high accuracy, because the processing that decodes the compressed data into the uncompressed data is performed on the server device 20 by the decoder 236. Moreover, because the playback device 30 needs only to perform the D/A conversion of the uncompressed data that was expanded by the server device 20 and to output the analog data, the playback device 30 does not need to be provided with a decoder or the like to decode the compressed data, so the playback device 30 can be manufactured at a low cost.

Streaming Playback Operation

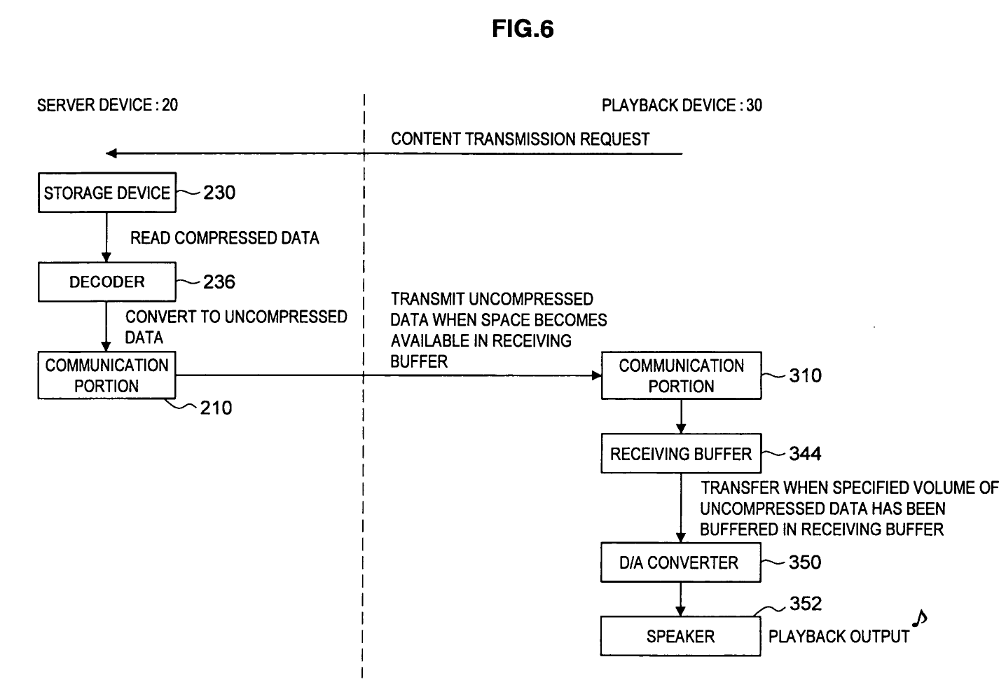

Next, the processing operations of the streaming transmission and the streaming playback of the content in the home network system 1 according to the present embodiment will be explained in general terms with reference to FIG. 6. Note that FIG. 6 is an explanatory figure that shows an overview of the streaming transmission process and the streaming playback process according to the present embodiment.

As shown in FIG. 6, the playback device 30 first transmits to the server device 20 the request to transmit the content that the user selected. The transmission request includes the address (for example, the URL) where the content is stored on the server device 20. When the content transmission request is received, the control portion 212 of the server device 20 sequentially reads out the compressed content data (the content may also be uncompressed data) from the storage device 230, starting at the beginning, and transfers the compressed data to the decoder 236. The read-out compressed data is expanded (decoded) into the uncompressed data (for example, the linear PCM data) by the decoder 236. Next, the server device 20 streams the decoded, uncompressed data to the playback device 30 through the communication portion 210 and the LAN 10. Note that in the present embodiment, TCP/IP, for example, is used as the communications protocol between the server device 20 and the playback device 30, but the present embodiment is not limited to this example, and it is also possible to communicate the data according to the User Datagram Protocol/Internet Protocol (UDP/IP) or the like, for example.

When the playback device 30 on the receiving side receives through the communication portion 310 the uncompressed data that was streamed from the server device 20 as described above, the playback device 30 first stores the data temporarily in the receiving buffer 344. The playback device 30 then transfers to the D/A converter 350 the data that was temporarily stored in the receiving buffer 344, performs the D/A conversion to create the analog format playback signal, outputs the analog format playback signal to the speaker 352, and performs the audio output. This series of buffering, D/A conversion, and audio output processes in the playback device 30 is called the streaming playback.

During the streaming playback, the playback control portion 328 controls the receiving of the uncompressed data by the communication portion 310, the writing to the recognize buffer 344, and the transfer of the uncompressed data to the D/A converter 350 such that the music content or the like is continuously played back in the preferred manner.

Specifically, when the playback device 30 starts receiving the uncompressed data and the volume of the uncompressed data that is stored in the receiving buffer 344 reaches a specified data volume on which the D/A converter 350 can perform the D/A conversion processing without any interruption of the output, the playback control portion 328 performs control such that the uncompressed data is read out from the receiving buffer 344 and transferred to the D/A converter 350. It is thus possible at the start of the streaming playback to prevent any interruption of the D/A conversion output and the sound that is caused by data transmission to the D/A converter 350 at a point when a sufficient volume of the uncompressed data has not yet been stored in the receiving buffer 344.

Furthermore, when space becomes available in the receiving buffer 344 due to the transmission of the data to the D/A converter 350, the playback control portion 328 issues through the communication portion 310 a request for the server device 20 to transmit the next portion of the uncompressed data, receives the next portion of the uncompressed data, and buffers it in the receiving buffer 344. Therefore, when there is no space available in the receiving buffer 344, the playback device 30 waits without receiving the uncompressed data from the server device 20.

The streaming transmission of the uncompressed data from the server device 20 to the playback device 30 and the streaming playback processing of the uncompressed data in the playback device 30 are performed continuously as described above. This is possible not only in a case where only one track of the content is played back independently, but also a plurality of the content files that belong to a specified playback range, such as one album, for example, are played back in order according to the track number (a first track, a second track, . . . and mth track (tune)).

Playback Switching Method

Next, the processing for switching the playback operation among the playback devices 30 in the home network system 1 according to the present embodiment will be explained. In the explanation that follows, an example of the switching of the playback operation between two playback devices 30A and 30B will be explained. In the home network system 1, the two playback devices 30A and 30B are connected through the LAN 10 to the same server device 20. The playback device 30A is installed in the living room, and the playback device 30B is installed in the bedroom.

1. Method of Switching the Playback from the Operated Playback Device 30 to Another of the Playback Devices 30 (the PUT Switching Processing)

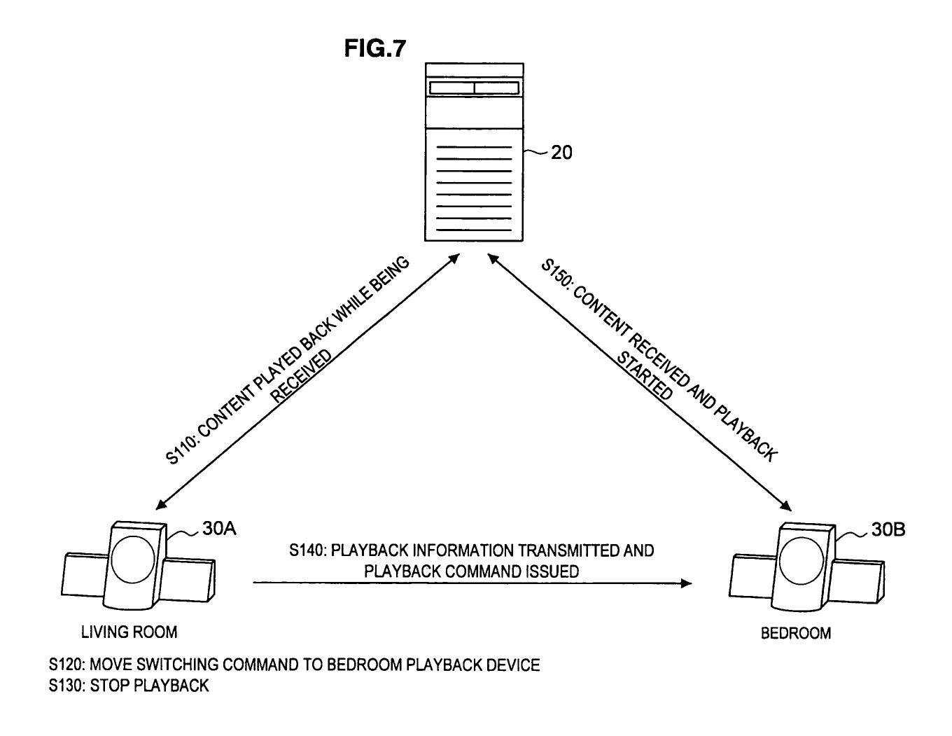

First, an overview of the playback switching operation between the playback devices 30 in a first case according to the present embodiment will be explained with reference to FIG. 7. The first case that is shown in FIG. 7 is a case where the user who is in the living room continues, on the playback device 30B in the bedroom, the playback of the content that is currently being played back on the playback device 30A in the living room. In this case, the playback device 30A in the living room that is operated by the user becomes the playback switching source playback device, and the remote playback device 30B in the bedroom becomes the playback switching destination playback device.

As shown in FIG. 7, first, the user is in the living room, and the playback device 30A in the living room is performing the playback (that is, the streaming playback) while receiving a plurality of the content files that are stored on the server device 20 (Step S110).

Next, the user operates the playback device 30A in the living room (the operated playback device 30) to select the remote playback device 30B in the bedroom as the playback switching destination, then presses the switching button of the input portion 330 to input the MOVE switching command (Step S120).

When the playback device 30A in the living room receives the MOVE switching command, it creates the playback information that includes the current playback mode information (the information that indicates repeat or no repeat, shuffle or no shuffle, and the like, and the playback range information, such as by album, by artist, or the like) on the playback device 30A, the attribute information (the URL, the title, or the like) for the content that is currently being played back on the playback device 30A, and the elapsed playback time for the content that is currently being played back. The playback device 30A in the living room then stops the content playback (Step S130). Next, the playback device 30A in the living room transmits the playback information and the playback start command to the playback device 30B in the bedroom through the LAN 10 (Step S140). At this time, the playback information is transmitted and received directly between the playback devices 30A and 30B, without going through the server device 20.

Next, when the playback device 30B in the bedroom (the playback switching destination playback device) receives the playback information from the playback device 30A in the living room (the playback switching source playback device), the playback device 30B in the bedroom, based on the playback information, receives the content from the server device 20 that is the content provision source and starts playing back the content (Step S150). Thus the user can move from the living room to the bedroom and hear the continuation of the content that is being played back on the playback device 30B in the bedroom.

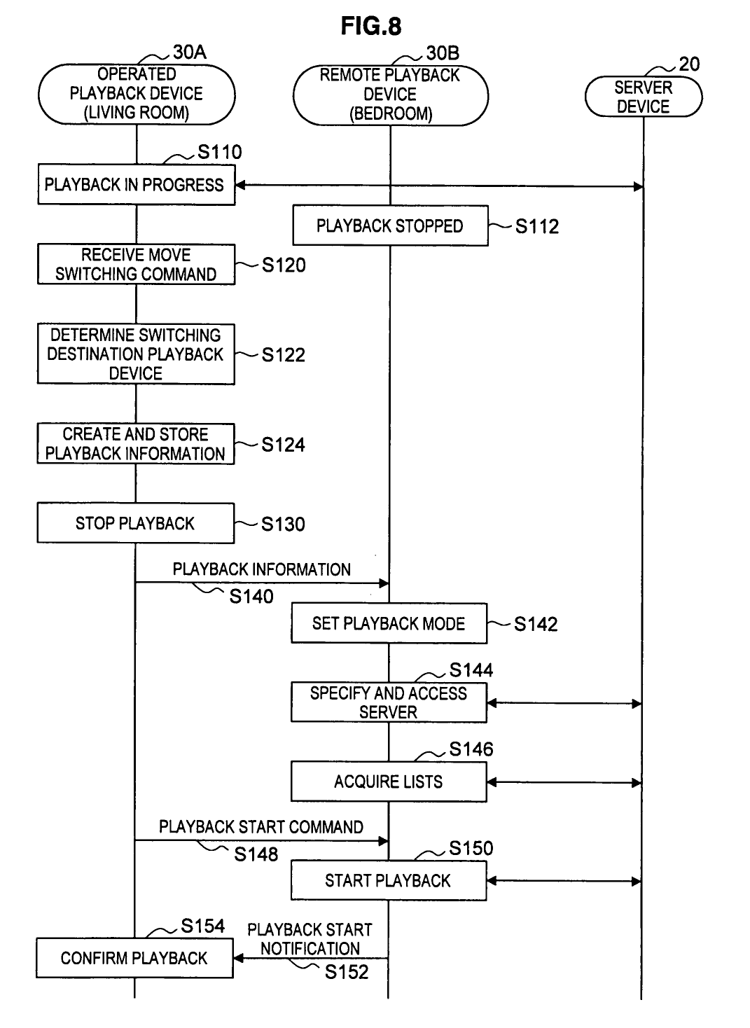

Next, the method of the playback switching between the playback devices 30 in the first case, which was explained using FIG. 7, will be explained in greater detail with reference to FIG. 8. FIG. 8 is a sequence chart that shows the method of the playback switching between the playback devices 30 in the first case according to the present embodiment.

As shown in FIG. 8, first, the playback device 30A in the living room, where the user is, is performing the playback while receiving the plurality of the content files in order from the server device 20 (Step S110). At this time, the playback is stopped, for example, on the playback device 30B in the bedroom (Step S112).

In the present embodiment, the user operates the input portion 330 of the playback device 30A in the living room to select the playback device 30B in the bedroom as the playback switching destination. When the user presses the switching button of the input portion 330 to input the MOVE switching command, the playback device 30A receives the MOVE switching command (Step S120).

Next, the playback device 30A in the living room determines the playback switching destination playback device 30 (Step S122). In a case where the playback switching destination playback device 30 has already been selected by the user when the switching command is input at Step S120, the determination processing determines the playback switching destination playback device 30 based on the user's selection.

On the other hand, in a case where the playback switching destination playback device 30 has not yet been selected by the user at Step S120, the playback device 30A in the living room searches for the other playback devices 30 within the network, identifies the other playback devices 30 to which the playback can be switched, then, based on the user's selection, determines the playback switching destination playback device 30 from among those other playback devices 30. For example, the playback device 30A in the living room determines which of the other playback devices 30 are connected to the LAN 10 and are in operation, then displays on the display portion 332 a list of the playback devices 30 that are candidates for the playback switching destination. The user then looks at the list display and uses a menu to select the playback switching destination playback device 30. When the user selects the playback switching destination playback device 30, the playback device 30A in the living room determines the playback switching destination playback device 30 according to the user's selection.

The search for and identification of each of the playback devices 30 on the LAN 10 are performed based on an identifier (for example, a UUID, a MAC address, or the like) that is uniquely assigned to each of the playback devices 30. When the playback device 30A in the living room transmits a search command over the LAN 10, the other playback devices 30 that are connected to the LAN 10, in response to the search command, return their own identifiers to the playback device 30 that is the source of the search command. Thus the playback device 30A can confirm the other playback devices 30 that are connected to the LAN 10.

When the list of the playback devices 30 that are candidates for the playback switching destination is displayed, the names (the friendly names) of the playback devices that are associated with the identifiers of the playback devices can also be displayed. The user can set the friendly names as desired and register them in the setting information storage portion 348. For example, “Bedroom” or the like can be set as the friendly name that indicates the playback device 30B in the bedroom. The user can thus easily identify the playback devices 30 that are the switching candidates.

Note that the explanation below assumes that at Step S122, the playback device 30B in the bedroom was determined to be the playback switching destination playback device 30.

Next, the playback device 30A in the living room creates and stores the playback information for the content that is currently being played back (Step S124). Specifically, the playback device 30A reads the currently set playback mode information from the setting information storage portion 348 and reads the content attribute information (the URL, the title, or the like) from the content information storage portion 346, then acquires the elapsed playback time for the content that is currently being played back. The playback device 30A then stores the playback information that includes the playback mode information, the content attribute information, and the elapsed playback time in the RAM or the like.

Next, the playback device 30A in the living room, immediately after storing the playback information at Step S124, for example, stops the playback of the content that is currently being played back (Step S130). Specifically, in response to a command from the playback switching portion 324, which has completed the creation and storage of the playback information, the playback control portion 328 of the playback device 30A controls the D/A converter 350 or the like such that the content playback processing is stopped. Note that the playback stop processing at Step S130 may be performed at any time, such as after the transmission of the playback information (Step S140), after the playback confirmation processing (Step S150), or the like, which are described later.

Next, the playback device 30A in the living room transmits the created playback information through the LAN 10 to the playback device 30B in the bedroom, which is the playback switching destination playback device 30, and the playback device 30B receives the playback information (Step S140).

Next, the playback device 30B in the bedroom, based on the playback mode information that is included in the received playback information, sets the playback mode of the playback device 30B to the same playback mode (repeat or no repeat, the unit of repetition, shuffle or no shuffle, the playback range of the continuously played back content, and the like) as that of the playback switching source playback device 30A (Step S142).

Based on the server information that is included in the playback information, the playback device 30B in the bedroom then specifies and accesses the server device 20 that is the content transmission source for the content that was being played back on the playback switching source playback device 30A (Step S144). More particularly, in a case where a plurality of the server devices 20 are present on the LAN 10, for example, the playback switching portion 324 of the playback device 30B, when the playback information is received, checks whether or not the server device 20 that corresponds to the server information (for example, the UUID) that is included in the playback information is the same as the server device 20 to which the playback device 30B is currently connected. If the server devices 20 are different, the playback switching portion 324 accesses the server device 20 that corresponds to the server information and connects the playback device 30B to it.

Based on the playback range information that is included in the playback mode information, the playback device 30B in the bedroom then acquires from the server device 20 lists of the content attribute information (including the URL, the title, and the like for each content file) by the genre, by the artist, by the album, and the like, for example (Step S146). By acquiring the lists, the playback device 30B becomes able to receive a plurality of the content files from the server device 20 and play them back in order in the same playback mode as on the playback device 30A in the living room. Specifically, in a case where the playback mode is continuous playback of the content in a certain genre, the playback device 30B first acquires a list of the artists that belong to the genre and selects one of the artists from the list. Next, the playback device 30B acquires an album list for the selected artist (including the album titles and information on the number of tracks on each album, for example) and selects one of the albums from the list. The playback device 30B then acquires a list of the tracks on the selected album (including the URL and the track title for each of the content files) and selects one of the tracks from the list. Finally, the playback device 30B requests the transmission of the content for the selected track from the server device 20.

Next, the playback device 30A in the living room transmits the playback start command to the playback device 30B in the bedroom, and the playback device 30B receives the playback start command (Step S148). The playback start command enables the playback switching destination playback device 30B to start the playback of the content. In other words, if the playback device 30B receives the playback start command, the playback device 30B starts the playback as soon as the playback preparation (receiving the content from the server device 20 and accumulating it in the receiving buffer 344) is completed. Note that the timing of the transmission of the playback start command is not limited to the timing of Step S148 and may also be, for example, any timing between the playback information transmission processing (Step S140) and the list acquisition processing (Step S146). Moreover, the function of the playback start command may also be fulfilled by the playback information transmission processing (Step S140) instead of by transmitting the playback start command from the playback device 30A to the playback device 30B.

Next, in response to the receiving of the playback start command, the playback device 30B in the bedroom receives the content from the server device 20 and starts playing back the content (Step S150). More particularly, the playback control portion 328 of the playback device 30B specifies the playback start position for the content to be played back, based on the content attribute information and the elapsed playback time that are included in the playback information. The playback control portion 328 then requests that the server device 20 transmit the content starting from the playback start position. In response to the transmission request, the server device 20 streams the content data that starts at the point of the elapsed playback time. When the playback control portion 328 receives from the server device 20 the content data that starts at the point of the elapsed playback time, it stores the data temporarily in the receiving buffer 344. The playback control portion 328 then reads the content from the receiving buffer 344, causes the D/A converter 350 to perform the D/A conversion of the content, and outputs the content as the analog format output signal to the speaker 352.

Once the playback of the content starts, not only the content that was being played back on the playback device 30A, but also the content that follows the content that was being played back (for example, the other content on the same album) is played back in order according to the playback mode that was set at Step S142.

Next, after the playback of the content starts, the playback device 30B in the bedroom transmits the playback start notification to the playback device 30A in the living room (Step S152). By receiving the playback start notification, the playback device 30A confirms that the playback has started on the playback switching destination playback device 30B (Step S154).

Thus, according to the playback switching method that is shown in FIGS. 7 and 8, the user can switch the content playback operation seamlessly from the playback device 30A in the living room to the playback device 30B in the bedroom just by performing a simple operation on the playback device 30A in the living room, without performing any sort of operation on the playback device 30B in the bedroom.

2. Method of Switching the Playback to the Operated Playback Device 30 from Another of the Playback Devices 30 (the GET Switching Processing)

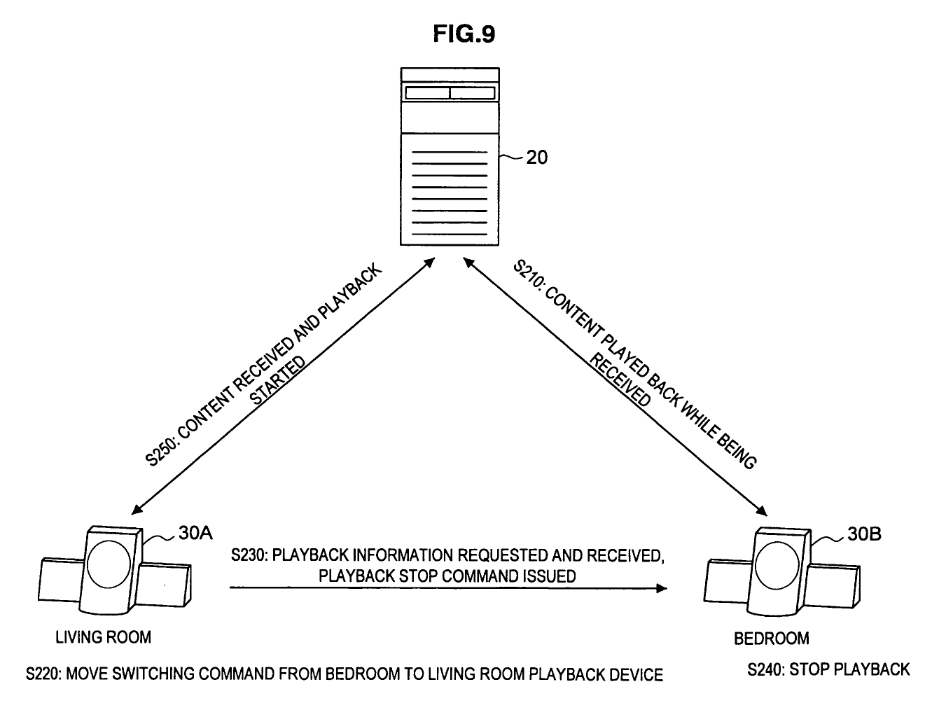

Next, an overview of the playback switching operation between the playback devices 30 in a second case according to the present embodiment will be explained with reference to FIG. 9. The second case that is shown in FIG. 9 is a case where the user in the living room continues, on the playback device 30A in the living room, the playback of the content that is currently being played back on the playback device 30B in the bedroom. In this case, the playback device 30A in the living room that is operated by the user becomes the playback switching destination playback device, and the remote playback device 30B in the bedroom becomes the playback switching source playback device.

As shown in FIG. 9, first, the playback device 30B in the bedroom is performing the playback (that is, the streaming playback) while receiving a plurality of the content files that are stored on the server device 20 (Step S210).

Next, the user operates the playback device 30A in the living room (the operated playback device 30) to select the remote playback device 30B in the bedroom as the playback switching source, then presses the switching button of the input portion 330 to input the MOVE switching command (Step S220).

When the playback device 30A in the living room receives the MOVE switching command, it transmits to the playback device 30B in the bedroom a request to transmit the playback information. The playback device 30A then receives the playback information that is transmitted from the playback device 30B in response to the transmission request and transmits the playback stop command to the playback device 30B (Step S230). The playback information that is transmitted from the playback device 30B includes the current playback mode on the playback device 30B, the attribute information for the content that is currently being played back on playback device 30B, and the elapsed playback time for the content that is currently being played back.

Next, when the playback device 30B in the bedroom receives the playback stop command from the playback device 30A, the playback device 30B stops the playback of the content (Step S240). Based on the playback information that was received from the playback device 30B, the playback device 30A in the living room (the playback switching destination playback device) receives the content from the server device 20 that is the content provision source and starts playing back the content (Step S250). Thus the user, while in the living room, can stop the playback on the playback device 30B in the bedroom and hear the continuation of the content that is being played back on the playback device 30A in the living room.

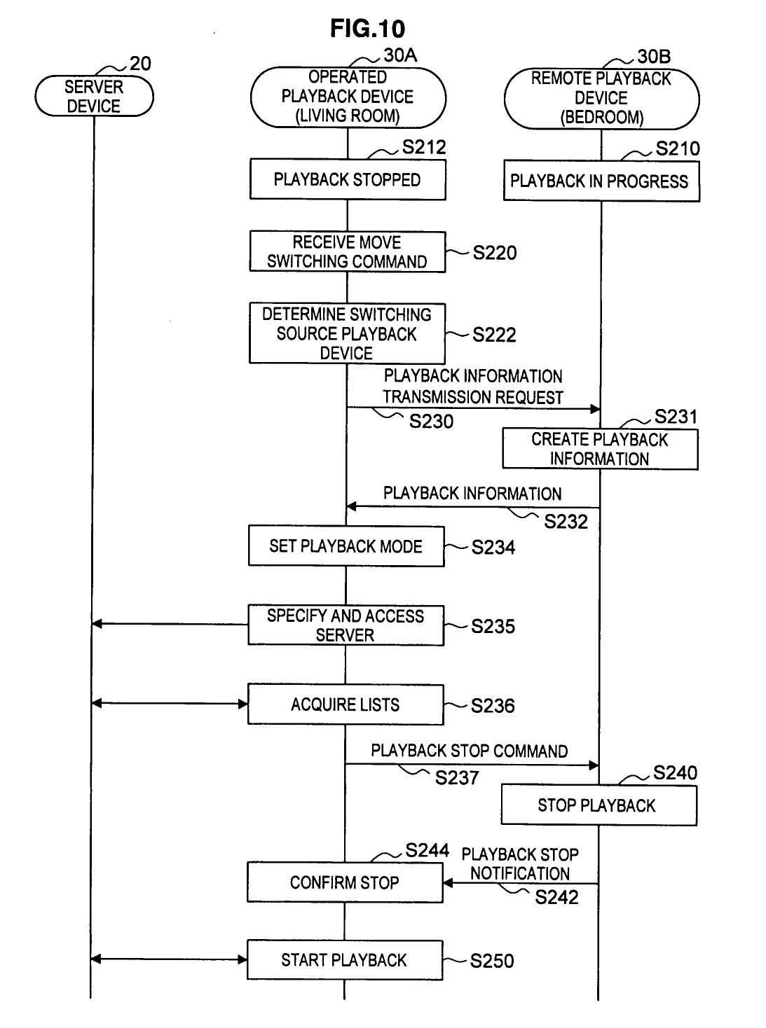

Next, the method of the playback switching between the playback devices 30 in the second case, which was explained using FIG. 9, will be explained in greater detail with reference to FIG. 10. FIG. 10 is a sequence chart that shows the method of the playback switching between the playback devices 30 in the second case according to the present embodiment.

As shown in FIG. 10, first, the playback is stopped, for example, on the playback device 30A in the living room, where the user is (Step S210). At this time, the playback device 30B in the bedroom is performing the playback while receiving the plurality of the content files in order from the server device 20 (Step S212).

In the present embodiment, the user operates the input portion 330 of the playback device 30A in the living room to select the playback device 30B in the bedroom as the playback switching source. When the user presses the switching button of the input portion 330 to input the MOVE switching command, the playback device 30A receives the MOVE switching command (Step S220).

Next, the playback device 30A in the living room determines that the playback device 30B in the bedroom is the playback switching source playback device 30 (Step S222). The details of the processing at Step S222 are roughly the same as those at Step S122 in FIG. 8, so a detailed explanation will be omitted.

Next, the playback device 30A in the living room transmits to the playback device 30B in the bedroom through the LAN 10 the request to transmit the playback information, and the playback device 30B receives the transmission request (Step S230).

The playback device 30B in the bedroom then creates the playback information that pertains to the content that is currently being played back (Step S231). Specifically, the playback device 30B reads out the currently set playback mode from the setting information storage portion 348, reads out from the content information storage portion 346 the attribute information for the content that is currently being played back (the URL, the title, and the like), and acquires the elapsed playback time for the content that is currently being played back. The playback device 30B then creates the playback information that includes the playback mode information, the content attribute information, and the elapsed playback time.

Next, the playback device 30B in the bedroom transmits the created playback information to the playback device 30A in the living room, and the playback device 30A receives the playback information (Step S232).

Next, based on the playback mode that is included in the received playback information, the playback device 30A in the living room sets its own playback mode to the same playback mode as that of the playback switching source playback device 30B (Step S234).

Based on the server information that is included in the playback information, the playback device 30A in the living room then specifies and accesses the server device 20 that is the content transmission source for the content that was being played back on the playback switching source playback device 30B (Step S235). The details of the processing at Step S235 are roughly the same as those at Step S144 in FIG. 8, so a detailed explanation will be omitted.

Based on the playback range information that is included in the playback mode information, the playback device 30A in the living room then acquires from the server device 20 lists of the content attribute information by the genre, by the artist, by the album, and the like, for example (Step S236). The details of the processing at Step S236 are roughly the same as those at Step S146 in FIG. 8, so a detailed explanation will be omitted.

Next, the playback device 30A in the living room transmits the playback stop command to the playback device 30B in the bedroom, and the playback device 30B receives the playback stop command (Step S237). Note that the timing of the transmission of the playback stop command is not limited to the timing of Step S237 and may also be, for example, any timing between the playback information transmission processing (Step S232) and the list acquisition processing (Step S236). Moreover, the function of the playback stop command may also be fulfilled by the playback information transmission processing (Step S230) instead of by transmitting the playback stop command from the playback device 30A to the playback device 30B.

Next, in response to the receiving of the playback stop command, the playback device 30B in the bedroom stops playing back the content (Step S240). Next, in response to the stopping of the playback, the playback device 30B in the bedroom transmits the playback stop notification through the LAN 10 to the playback device 30A in the living room, and the playback device 30A receives the playback stop notification (Step S242). By receiving the playback start notification, the playback device 30A in the living room confirms that the playback has stopped on the playback switching source playback device 30B (Step S244).

The playback device 30A in the living room then receives the content from the server device 20 and starts playing back the content (Step S250). The details of the processing at Step S250 are roughly the same as those at Step S150 in FIG. 8, so a detailed explanation will be omitted. Note that in this processing flow, the playback device 30A in the living room starts the playback after confirming that the playback has stopped on the playback device 30B in the bedroom, but the present embodiment is not limited by this example, and the confirmation that the playback has stopped on the playback device 30B is not necessarily required. The playback device 30A may also start the playback as soon as its own playback preparation (receiving the content from the server device 20 and accumulating it in the receiving buffer 344) is completed.

Thus, according to the playback switching method that is shown in FIGS. 9 and 10, the user can switch the content playback operation seamlessly from the playback device 30B in the bedroom to the playback device 30A in the living room just by performing a simple operation on the playback device 30A in the living room, without performing any sort of operation on the playback device 30B in the bedroom.

3. Modified Example of the Method of Switching the Playback from the Operated Playback Device 30 to Another of the Playback Devices 30

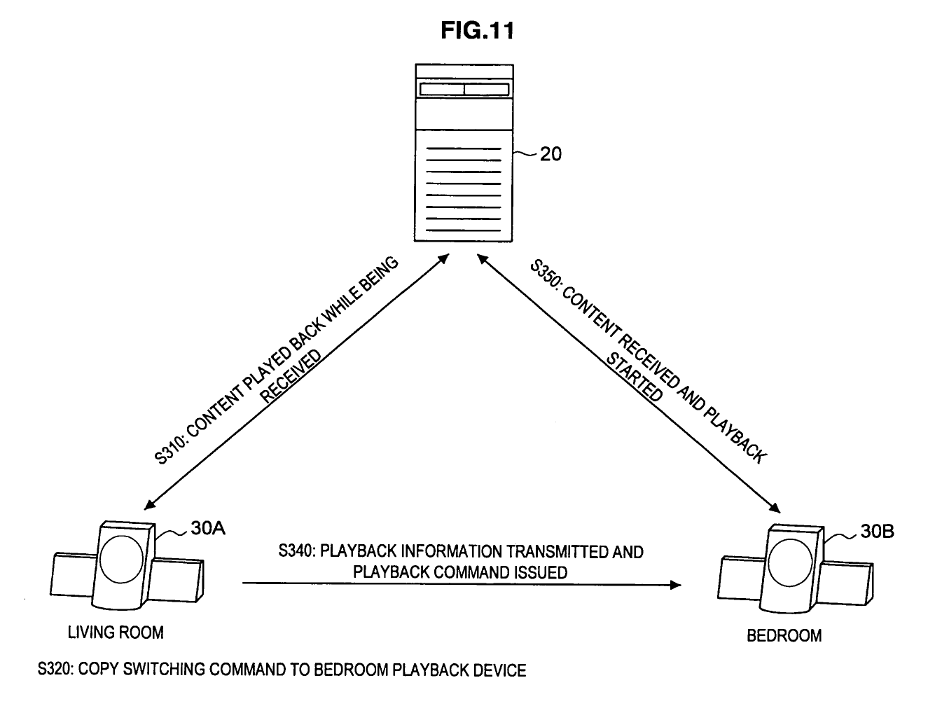

Next, an overview of the playback switching operation between the playback devices 30 in a third case according to the present embodiment will be explained with reference to FIG. 11. The third case that is shown in FIG. 7 is a case where the user who is in the living room simultaneously plays back, on the playback device 30B in the bedroom, the content that is currently being played back on the playback device 30A in the living room. In this case, the playback device 30A in the living room that is operated by the user becomes the playback switching source playback device, and the remote playback device 30B in the bedroom becomes the playback switching destination playback device.

As shown in FIG. 11, first, the user is in the living room, and the playback device 30A in the living room is performing the playback (that is, the streaming playback) while receiving a plurality of the content files that are stored on the server device 20 (Step S310).

Next, the user operates the playback device 30A in the living room (the operated playback device 30) to select the remote playback device 30B in the bedroom as the playback switching destination, then presses the switching button of the input portion 330 to input the COPY switching command (Step S320).

When the playback device 30A in the living room receives the COPY switching command, it creates the playback information that pertains to the content that is currently being played back on the playback device 30A, in the same manner as in the example in FIG. 7. Next, the playback device 30A in the living room transmits the playback information and the playback start command to the playback device 30B in the bedroom through the LAN 10 (Step S340). At this time, the playback information is transmitted and received directly between the playback devices 30A and 30B, without going through the server device 20.

Next, when the playback device 30B in the bedroom (the playback switching destination playback device) receives the playback information from the playback device 30A in the living room (the playback switching source playback device), the playback device 30B in the bedroom, based on the playback information, receives the content from the server device 20 that is the content provision source and starts playing back the content (Step S350).

Thus, in the third case, it is possible to perform the playback continuously on the playback switching source playback device 30A in the living room, without stopping the playback, and to play back the same content on both the playback device 30A and the playback device 30B in the bedroom. Thus the user can, by a simple operation, hear the same content in both the living room and the bedroom.

Note that the detailed flow of the playback switching processing in the third case is roughly the same as the flow in FIG. 8 described above in the first case, except for the point that the COPY command is received at Step S120 and the point that the playback stop processing at Step S130 is not performed, so a detailed explanation will be omitted.

4. Modified Example of the Method of Switching the Playback to the Operated Playback Device 30 from Another of the Playback Devices 30

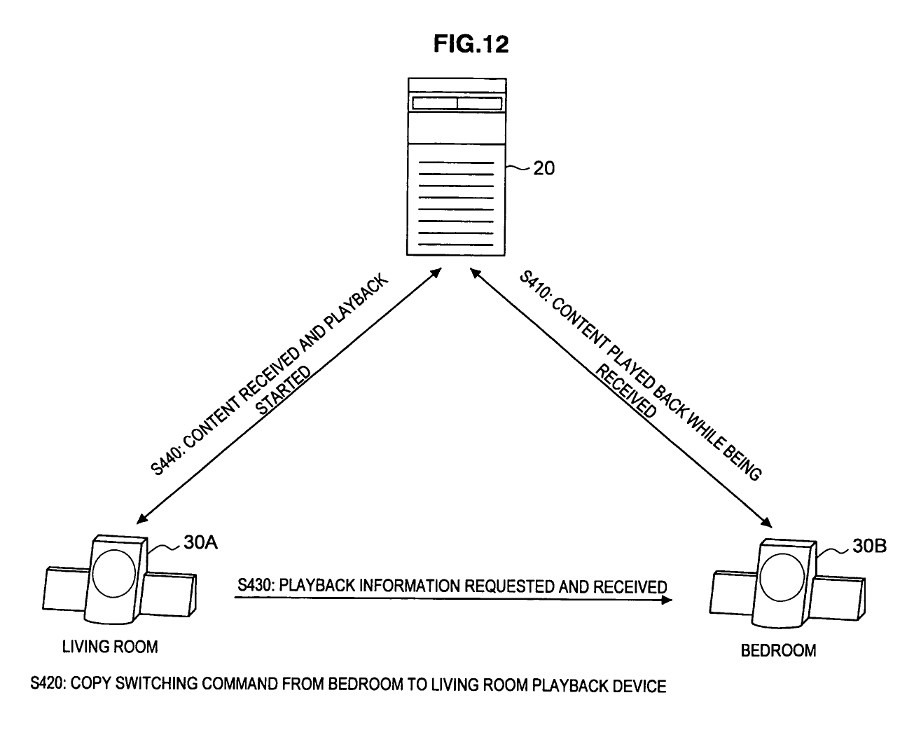

Next, an overview of the playback switching operation between the playback devices 30 in a fourth case according to the present embodiment will be explained with reference to FIG. 12. The fourth case that is shown in FIG. 12 is a case where the user who is in the living room simultaneously plays back, on the playback device 30A in the living room, the content that is currently being played back on the playback device 30B in the bedroom. In this case, the playback device 30A in the living room that is operated by the user becomes the playback switching destination playback device, and the remote playback device 30B in the bedroom becomes the playback switching source playback device.

As shown in FIG. 12, first, the playback device 30B in the bedroom is performing the playback (that is, the streaming playback) while receiving a plurality of the content files that are stored on the server device 20 (Step S410).

Next, the user operates the playback device 30A in the living room (the operated playback device 30) to select the remote playback device 30B in the bedroom as the playback switching source, then presses the switching button of the input portion 330 to input the COPY switching command (Step S420).

When the playback device 30A in the living room receives the COPY switching command, it transmits to the playback device 30B in the bedroom through the LAN 10 a request to transmit the playback information. The playback device 30A then receives the playback information that is transmitted from the playback device 30B in response to the transmission request (Step S430). The playback information that is transmitted from the playback device 30B includes the current playback mode on the playback device 30B, the attribute information for the content that is currently being played back on playback device 30B, and the elapsed playback time for the content that is currently being played back.

Based on the playback information that was received from the playback device 30B, the playback device 30A in the living room (the playback switching destination playback device) receives the content from the server device 20 that is the content provision source and starts playing back the content (Step S440).

Thus, in the fourth case, it is possible to perform the playback continuously on the playback switching source playback device 30B in the bedroom, without stopping the playback, and to play back the same content on both the playback device 30B and the playback device 30A in the living room. Thus the user can, by a simple operation, hear the same content in both the living room and the bedroom.

Note that the detailed flow of the playback switching processing in the fourth case is roughly the same as the flow in FIG. 10 described above in the second case, except for the point that the COPY command is received at Step S220 and the point that the playback stop processing at Steps S237 to S244 is not performed, so a detailed explanation will be omitted.

The home network system 1 according to the present embodiment, the server devices 20 and the playback devices 30 that make up the home network system 1, and the playback switching method in the system were explained in detail above. According to the present embodiment, in a case where a plurality of the playback devices 30 that can receive and play back the content from the server devices 20 are installed in the home network, even if the same playback operation is not performed separately on each of the playback devices 30, it is possible to switch the playback operation on the playback devices 30 by performing the switching command operation on only one of the playback devices 30. This makes it possible for the content that is being played back on one of playback devices 30 to be played back continuously on another of the playback devices 30 in the same manner, continuing in the same playback mode and from the same elapsed playback time. It is thus easily possible, by a simple user operation, to perform the switching processing for seamless playback operation between separated playback devices 30.

It is also possible for the playback switching processing to be achieved by the direct transmission and receiving of the playback information and control signals among the plurality of the playback devices 30 that are connected to the LAN 10, without going through the server devices 20. Therefore, it is not necessary to use a server for registering the setting information, as is known to have been done. Accordingly, the playback operation can be switched among the playback devices 30 by a simple operation, even if a server that has a function for registering the setting information is not installed. Moreover, the server device 20 is not limited to a specific model made by a specific manufacturer, so a general-purpose server can be used.

Furthermore, the playback switching processing among the playback devices 30 can be performed by operating the playback device 30 that is close to the user, whether that playback device 30 is the playback device 30 that is currently playing back the content or is a playback device 30 on which the playback is stopped.

It should be understood by those skilled in the art that various modifications, combinations, sub-combinations and alterations may occur depending on design requirements and other factors insofar as they are within the scope of the appended claims or the equivalents thereof.

For example, in the embodiment described above, an example was explained in which the server devices 20 as home servers and the playback devices 30 are connected through the LAN 10 for the home network in a home, but the present invention is not limited by this example. For example, the present invention can be used in a case where the server devices 20 and the plurality of the playback devices 30 are mutually connected such that one of wired and wireless communication is possible through a private network other than the home network (for example, a LAN that connects a plurality of devices that are used within a limited, small-scale group (a company, friends, or the like)), a public circuit network such as the Internet, a telephone circuit network, a satellite communications network, or the like, a wireless communications route, or the like.

Furthermore, in the embodiment described above, the server device 20 decodes the compressed content data that is stored on the server device 20 and transmits the uncompressed data to the playback device 30, but the present invention is not limited by this example. For example, the compressed content data that is stored on the server device 20 may also be transmitted to the playback device 30 in its existing form. The playback device 30 may also be provided with a decoder such that the expansion and D/A conversion of the compressed content data that is transmitted from the server device 20 may be done on the playback device 30.

Further, in the playback switching operation in the embodiment described above (FIGS. 7 to 12), the playback switching processing is performed from the playback device 30 on which the content is currently being played back to the playback device 30 that is stopped, but the present invention is not limited by this example. For example, the present invention can also be used in a case where the playback switching is performed from a playback device 30 on which one content file is currently being played back to a playback device 30 that is currently playing back a different content file. In this case, the playback of the content that is being played back on the playback switching destination playback device 30 is stopped, and the switch is made to the playback of the new content.

Furthermore, in the playback switching operation in the embodiment described above, in a case where the content playback switching is performed, the playback switching destination playback device 30 newly acquires the playback range lists from the server device 20, but the present invention is not limited by this example. For example, the list acquisition processing can be eliminated by having the playback switching source playback device 30 transmit all of the playback range lists to the playback switching destination playback device 30.

What is claimed is:

1. A content playback system in which a first playback device and a second playback device that can receive and play back content from a server device are connected by one of a wired connection and a wireless connection, wherein
when the first playback device, while receiving and playing back the content from the server device, receives a switching command for causing the content that is currently being played back to be played back on the second playback device, the first playback device transmits to the second playback device playback information that includes attribute information and an elapsed playback time for the content that is currently being played back, and
when the second playback device receives the playback information from the first playback device, the second playback device, based on the playback information, receives from the server device and plays back data that starts from the elapsed playback time for the content.

2. A playback device, comprising:
a communication portion that communicates data to and from at least one of a server device and an other playback device;
a playback portion that plays back content that is received from the server device by the communication portion; and
a playback switching portion that, when it receives a switching command while the content is being played back by the playback portion, transmits to the other playback device through the communication portion playback information that includes attribute information and an elapsed playback time for the content that is currently being played back.

3. The playback device according to claim 2, wherein the playback information further includes playback mode information that indicates a playback mode that is currently set on the playback device.

4. The playback device according to claim 3, wherein the playback mode includes at least one of a one track repeat playback mode, an album repeat playback mode, an all content continuous playback mode, a shuffle playback mode, and a random playback mode.

5. The playback device according to claim 3, wherein the playback mode information includes playback range information that indicates a range of the content that is subject to playback.

6. The playback device according to claim 2, wherein the playback information further includes server information that pertains to the server device that is the transmission source for the content that is currently being played back.

7. The playback device according to claim 2, further comprising:
a switching function setting portion that sets to ON and OFF a function by which the playback switching portion switches the playback of the content to the other playback device.

8. The playback device according to claim 2, wherein the playback switching portion, when the switching command is received, searches for and finds at least one other playback device that is capable of communicating data to and from the playback device, and then determines which of the at least one other playback device that has been found is the other playback device that is the destination of the playback switching of the content.

9. The playback device according to claim 2, wherein the playback switching portion, after the switching command is received, stops the playback of the content by the playback portion and transmits to the other playback device the elapsed playback time at the time that the playback was stopped.

10. The playback device according to claim 2, wherein the playback switching portion, after the playback information is transmitted to the other playback device, transmits a playback start command to the other playback device.

11. The playback device according to claim 2, wherein the playback switching portion receives from the other playback device a playback start notification that the playback of the content has started on the other playback device.

12. The playback device according to claim 11, wherein the playback switching portion, after it receives the playback start notification, stops the playback of the content by the playback portion.

13. A playback device, comprising:
a communication portion that communicates data to and from at least one of a server device and an other playback device;
a playback portion that plays back content that is received from the server device by the communication portion;
a playback switching portion that receives from the other playback device through the communication portion playback information that includes attribute information and an elapsed playback time for the content that is currently being played back on the other playback device; and
a playback control portion that, based on the playback information, receives from the server device through the communication portion data that starts from the elapsed playback time for the content and performs control such that the content is played back by the playback portion.

14. The playback device according to claim 13, wherein
the playback information further includes playback mode information that indicates a playback mode that is currently set on the other playback device, and
the playback control portion performs control such that the content is played back based on the playback mode information.

15. The playback device according to claim 14, wherein the playback mode includes at least one of a one track repeat playback mode, an album repeat playback mode, an all content continuous playback mode, a shuffle playback mode, and a random playback mode.

16. The playback device according to claim 14, wherein
the playback mode information includes playback range information that indicates a range of the content that is subject to playback, and
the playback control portion, based on the playback range information, specifies the playback range of the content that is played back by the playback portion.

17. The playback device according to claim 13, wherein
the playback information further includes server information that pertains to the server device that is the transmission source for the content that is currently being played back, and
the playback control portion, based on the server information, specifies the server device that is the transmission source for the content that is currently being played back.

18. The playback device according to claim 13, further comprising:
a switching function setting portion that sets to ON and OFF a function by which the playback switching portion switches the playback of the content from the other playback device.

19. The playback device according to claim 13, wherein the playback control portion, after a playback start command is received from the other playback device, performs control such that the playback of the content by the playback portion starts, based on the playback information.

20. The playback device according to claim 13, wherein the playback switching portion, after the playback of the content by the playback portion has started, transmits a playback start notification to the other playback device.

21. A playback switching method in a playback device that is connected by one of a wired connection and a wireless connection to at least one of a server device and an other playback device, the playback switching method comprising the steps of:
receiving content from the server device and playing back the content;
receiving a switching command, while the content is being played back, to play back on the other playback device the content that is currently being played back; and
transmitting to the other playback device, in response to the receiving of the switching command, playback information that includes attribute information and an elapsed playback time for the content that is currently being played back.

22. A playback switching method in a playback device that is connected by one of a wired connection and a wireless connection to at least one of a server device and an other playback device, the playback switching method comprising the steps of:
receiving from the other playback device playback information that includes attribute information and an elapsed playback time for the content that is currently being played back on the other playback device; and
performing control, based on the playback information, such that data that starts from the elapsed playback time for the content is received from the server device and played back.

23. A program that causes a computer that makes up a playback device that is connected by one of a wired connection and a wireless connection to at least one of a server device and an other playback device to perform the steps of:
receiving content from the server device and playing back the content;
receiving a switching command, while the content is being played back, to play back on the other playback device the content that is currently being played back; and
transmitting to the other playback device, in response to the receiving of the switching command, playback information that includes attribute information and an elapsed playback time for the content that is currently being played back.

24. A program that causes a computer that makes up a playback device that is connected by one of a wired connection and a wireless connection to at least one of a server device and an other playback device to perform the steps of:
receiving from the other playback device playback information that includes attribute information and an elapsed playback time for the content that is currently being played back on the other playback device; and
performing control, based on the playback information, such that data that starts from the elapsed playback time for the content is received from the server device and played back.

25. A content playback system in which a first playback device and a second playback device that can receive and play back content from a server device are connected by one of a wired connection and a wireless connection, wherein
when the first playback device receives a switching command for causing the content that is currently being played back on the second playback device to be played back on the first playback device, the first playback device transmits to the second playback device a transmission request for playback information,
when the second playback device, while receiving and playing back the content from the server device, receives from the first playback device the transmission request for the playback information, the second playback device transmits to the first playback device playback information that includes attribute information and an elapsed playback time for the content that is currently being played back, and
when the first playback device receives the playback information from the second playback device, the first playback device, based on the playback information, receives from the server device and plays back data that starts from the elapsed playback time for the content.

26. A playback device, comprising:
a communication portion that communicates data to and from at least one of a server device and an other playback device;
a playback portion that plays back content that is received from the server device by the communication portion;
a playback switching portion that, when it receives a switching command, transmits to the other playback device through the communication portion a transmission request for playback information and, in response to the transmission of the transmission request for the playback information, receives from the other playback device through the communication portion the playback information that includes attribute information and an elapsed playback time for the content that is currently being played back on the other playback device; and
a playback control portion that, based on the playback information, receives from the server device through the communication portion data that starts from the elapsed playback time for the content and performs control such that the content is played back by the playback portion.

27. The playback device according to claim 26, wherein
the playback information further includes playback mode information that indicates a playback mode that is currently set on the other playback device, and
the playback control portion performs control such that the content is played back based on the playback mode information.

28. The playback device according to claim 27, wherein the playback mode includes at least one of a one track repeat playback mode, an album repeat playback mode, an all content continuous playback mode, a shuffle playback mode, and a random playback mode.

29. The playback device according to claim 27, wherein
the playback mode information includes playback range information that indicates a range of the content that is subject to playback, and
the playback control portion, based on the playback range information, specifies the playback range of the content that is played back by the playback portion.

30. The playback device according to claim 26, wherein
the playback information further includes server information that pertains to the server device that is the transmission source for the content that is currently being played back, and
the playback control portion, based on the server information, specifies the server device that is the transmission source for the content that is currently being played back.

31. The playback device according to claim 26, further comprising:
a switching function setting portion that sets to ON and OFF a function by which the playback switching portion switches the playback of the content from the other playback device.

32. The playback device according to claim 26, wherein the playback switching portion, when the switching command is received, searches for and finds at least one other playback device that is capable of communicating data to and from the playback device, and then determines which of the at least one other playback device that it has found is the playback device that is the source of the playback switching of the content.

33. The playback device according to claim 26, wherein the playback switching portion, after the playback information is received from the other playback device, transmits a playback stop command to the other playback device.

34. The playback device according to claim 26, wherein the playback switching portion receives from the other playback device a playback stop notification that the playback of the content has stopped on the other playback device.

35. The playback device according to claim 34, wherein the playback switching portion, after it receives the playback stop notification, starts the playback of the content by the playback portion.

36. A playback device, comprising:
a communication portion that communicates data to and from at least one of a server device and an other playback device;
a playback portion that plays back content that is received from the server device by the communication portion; and
a playback switching portion that, when it receives from the other playback device through the communication portion a transmission request for playback information while the content is being played back by the playback portion, transmits to the other playback device playback information that includes attribute information and an elapsed playback time for the content that is currently being played back.

37. The playback device according to claim 36, wherein the playback information further includes playback mode information that indicates a playback mode that is currently set on the playback device.

38. The playback device according to claim 37, wherein the playback mode includes at least one of a one track repeat playback mode, an album repeat playback mode, an all content continuous playback mode, a shuffle playback mode, and a random playback mode.

39. The playback device according to claim 37, wherein the playback mode information includes playback range information that indicates a range of the content that is subject to playback.

40. The playback device according to claim 36, wherein the playback information further includes server information that pertains to the server device that is the transmission source for the content that is currently being played back.

41. The playback device according to claim 36, further comprising:
a switching function setting portion that sets to ON and OFF a function by which the playback switching portion switches the playback of the content to the other playback device.

42. The playback device according to claim 36, wherein the playback control portion, after a playback stop command is received from the other playback device, stops the playback of the content by the playback portion.

43. The playback device according to claim 36, wherein the playback switching portion, after the playback of the content by the playback portion has stopped, transmits a playback stop notification to the other playback device.

44. A playback switching method in a playback device that is connected by one of a wired connection and a wireless connection to at least one of a server device and an other playback device, the playback switching method comprising the steps of:
receiving a switching command to play back on the playback device content that is currently being played back on the other playback device;
transmitting to the other playback device, in response to the receiving of the switching command, a transmission request for playback information;
receiving from the other playback device, in response to the transmission of the transmission request for the playback information, the playback information that includes attribute information and an elapsed playback time for the content that is currently being played back on the other playback device; and
performing control, based on the playback information, such that data that starts from the elapsed playback time for the content is received from the server device and played back.

45. A playback switching method in a playback device that is connected by one of a wired connection and a wireless connection to at least one of a server device and an other playback device, the playback switching method comprising the steps of:
receiving content from the server device and playing back the content;
receiving from the other playback device, while the content is being played back, a transmission request for playback information; and
transmitting to the other playback device, in response to the receiving of the transmission request, the playback information that includes attribute information and an elapsed playback time for the content that is currently being played back.

46. A program that causes a computer that makes up a playback device that is connected by one of a wired connection and a wireless connection to at least one of a server device and an other playback device to perform the steps of:
receiving a switching command to play back on the playback device content that is currently being played back on the other playback device;
transmitting to the other playback device, in response to the receiving of the switching command, a transmission request for playback information;
receiving from the other playback device, in response to the transmission of the transmission request for the playback information, the playback information that includes attribute information and an elapsed playback time for the content that is currently being played back on the other playback device; and
performing control, based on the playback information, such that data that starts from the elapsed playback time for the content is received from the server device and played back.

47. A program that causes a computer that makes up a playback device that is connected by one of a wired connection and a wireless connection to at least one of a server device and an other playback device to perform the steps of:
receiving content from the server device and playing back the content;
receiving from the other playback device, while the content is being played back, a transmission request for playback information; and
transmitting to the other playback device, in response to the receiving of the transmission request, the playback information that includes attribute information and an elapsed playback time for the content that is currently being played back.
